(19) United States
(12) Patent Application Publication
(10) Pub. No.: US 2019/0213131 A1
(43) Pub. Date: Jul. 11, 2019

(54) STREAM CACHE

(71) Applicants: Ariel Sabba, Lavon (IL); Shani Rehana, Shoam (IL); Michael Tal, Yoqneam Illit (IL); Suzan Baransi, Nazareth Illit (IL); Lihu Rappoport, Haifa (IL); Jared Warner Stark, Portland, OR (US); Franck Sala, Haifa (IL)

(72) Inventors: Ariel Sabba, Lavon (IL); Shani Rehana, Shoam (IL); Michael Tal, Yoqneam Illit (IL); Suzan Baransi, Nazareth Illit (IL); Lihu Rappoport, Haifa (IL); Jared Warner Stark, Portland, OR (US); Franck Sala, Haifa (IL)

(21) Appl. No.: 15/868,342

(22) Filed: Jan. 11, 2018

(51) Int. Cl. G06F 12/0862; G06F 12/0875

(52) U.S. Cl. CPC G06F 12/0862; G06F 2212/452; G06F 2212/6026; G06F 12/0875

(57) ABSTRACT

Systems and methods for stream cache memory retrieval include applying a stream cache to predict a sequence of instructions and data across multiple branches. Similar to a conventional computing cache, the stream cache stores and provides data or instructions more quickly than provided by slower data storage media, such as an instruction cache. The stream cache described herein provides the ability to predict instructions and data requests across multiple branches per cycle, and in particular across multiple taken branches per cycle. This stream cache increases instruction supply bandwidth while reducing overall power consumption by saving cycles of the branch predictor structures.

### TECHNICAL FIELD

Embodiments described herein generally relate to computing device cache operation.

### BACKGROUND

There is an ongoing demand for improved computer processing efficiency. Processing efficiency is based in part on a processor instruction bandwidth, which includes a processor's ability to identify, fetch, receive, and process data or instructions. Some computing devices use stream processing to apply a series of operations to a sequence of data. When fetching a defined sequence of instructions and data, the memory access pattern for that sequence of data may be predicted based on the expected data within the sequence. However, a sequence of data may branch into different sequences based on the output of preceding operations, which reduces stream processing performance and increases device power consumption.

### BRIEF DESCRIPTION OF THE DRAWINGS

FIG. 1 is a block diagram illustrating a stream cache line according to an embodiment.

FIG. 2 is a block diagram illustrating a stream cache architecture according to an embodiment.

FIG. 3 is a block diagram of a stream cache method, in accordance with at least one embodiment.

FIG. 4 is a block diagram illustrating a stream cache system in the example form of an electronic device, according to an example embodiment.

FIGS. 5A-5B are block diagrams illustrating a generic vector friendly instruction format and instruction templates thereof according to an embodiment.

FIG. 6A-6D are block diagrams illustrating an exemplary specific vector friendly instruction format according to an embodiment.

FIG. 7 is a block diagram of a register architecture according to one embodiment of the invention.

FIG. 8A is a block diagram illustrating both an exemplary in-order pipeline and an exemplary register renaming, out-of-order issue/execution pipeline according to an embodiment.

FIG. 8B is a block diagram illustrating both an exemplary embodiment of an in-order architecture core and an exemplary register renaming, out-of-order issue/execution architecture core to be included in a processor according to an embodiment.

FIG. 9A-9B illustrate a block diagram of a more specific exemplary in-order core architecture, which core would be one of several logic blocks (including other cores of the same type and/or different types) in a chip.

FIG. 10 is a block diagram of a processor that may have more than one core, may have an integrated memory controller, and may have integrated graphics according to an embodiment.

FIG. 11 is a block diagram of a system in accordance with one embodiment.

FIG. 12 is a block diagram of a first more specific exemplary system in accordance with an embodiment.

FIG. 13 is a block diagram of a second more specific exemplary system in accordance with an embodiment.

FIG. 14 is a block diagram of a SoC in accordance with an embodiment.

FIG. 15 is a block diagram contrasting the use of a software instruction converter to convert binary instructions in a source instruction set to binary instructions in a target instruction set according to an embodiment.

### DESCRIPTION OF EMBODIMENTS

One solution to problems facing stream processing includes applying a stream cache to predict a sequence of instructions and data across multiple branches. Similar to a conventional computing cache, the stream cache stores and provides data or instructions more quickly than provided by an instruction cache. The stream cache described herein provides the ability to predict instructions and data requests across multiple branches per cycle, and in particular across multiple taken branches per cycle. This stream cache increases instruction supply bandwidth while reducing overall power consumption by saving cycles of the branch predictor structures.

The following description and the drawings illustrate example embodiments, though other embodiments may incorporate structural, logical, electrical, process, and other changes. Portions and features of various embodiments may be included in, or substituted for, those of other embodiments. Embodiments set forth in the claims encompass all available equivalents of those claims.

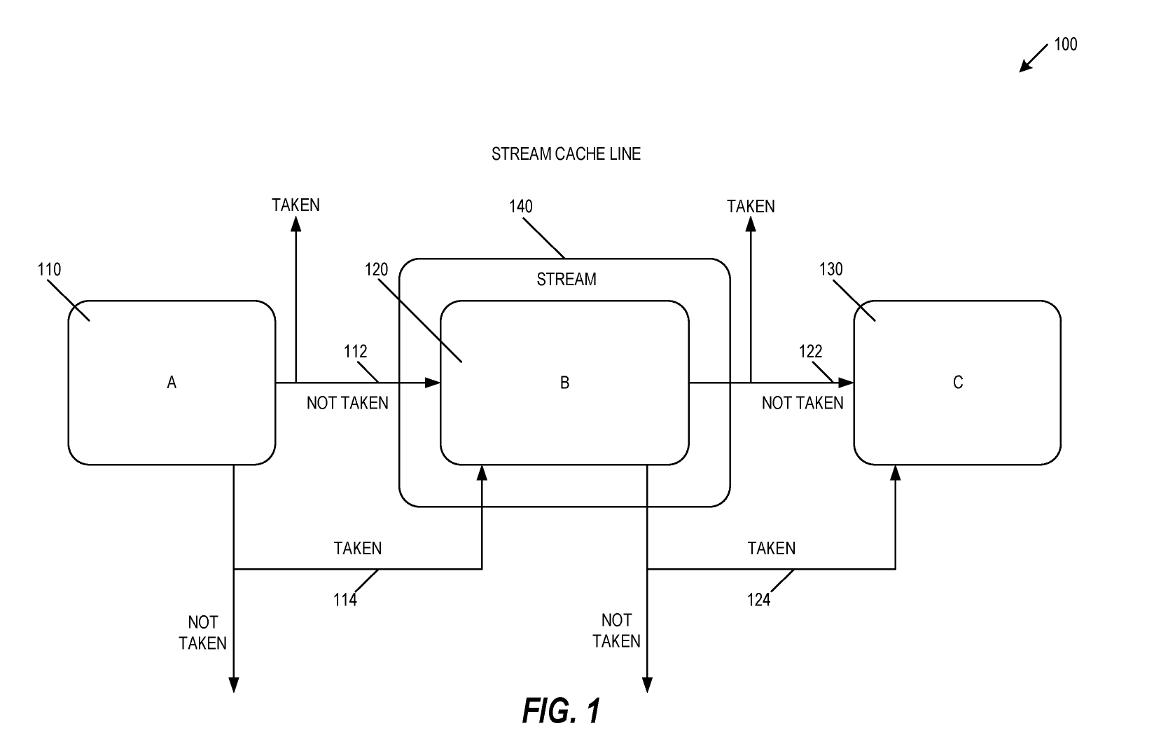

FIG. 1 is a block diagram illustrating a stream cache line 100 according to an embodiment. The stream cache line 100 shows three fetch blocks, block A 110, block B 120, and block C 130. Each of these blocks represents a fetch (e.g., retrieval) of data, such as a line of code retrieved for execution. Each of the three blocks (e.g., three lines of code) may be accessed individually, or may be accessed in any order. Many computing operations use a consistent sequence of lines of code. FIG. 1 shows an example of three sequential blocks. The stream cache may track and identify groups of sequential blocks as a stable line (e.g., a stable stream), where the stable stream defines a particular sequence of instructions.

As shown in FIG. 1, stream cache line 100 includes a fetch of block A 110, followed by a fetch of block B 120, followed by a fetch of block C 130. In an example, the stream cache identifies that block B 120 is part of a stable line, and when the stream cache subsequently fetches block B 120, it automatically fetches both block A 110 and block B 120. The stream cache may also predict the fetching of block B 120, and may fetch both block A 110 and block B 120 in response to that prediction. This increases the fetch bandwidth, which improves electronic device processing performance. In an example, the increased fetch bandwidth increases a device performance by providing retrieved instructions to the processor as quickly as can be processed.

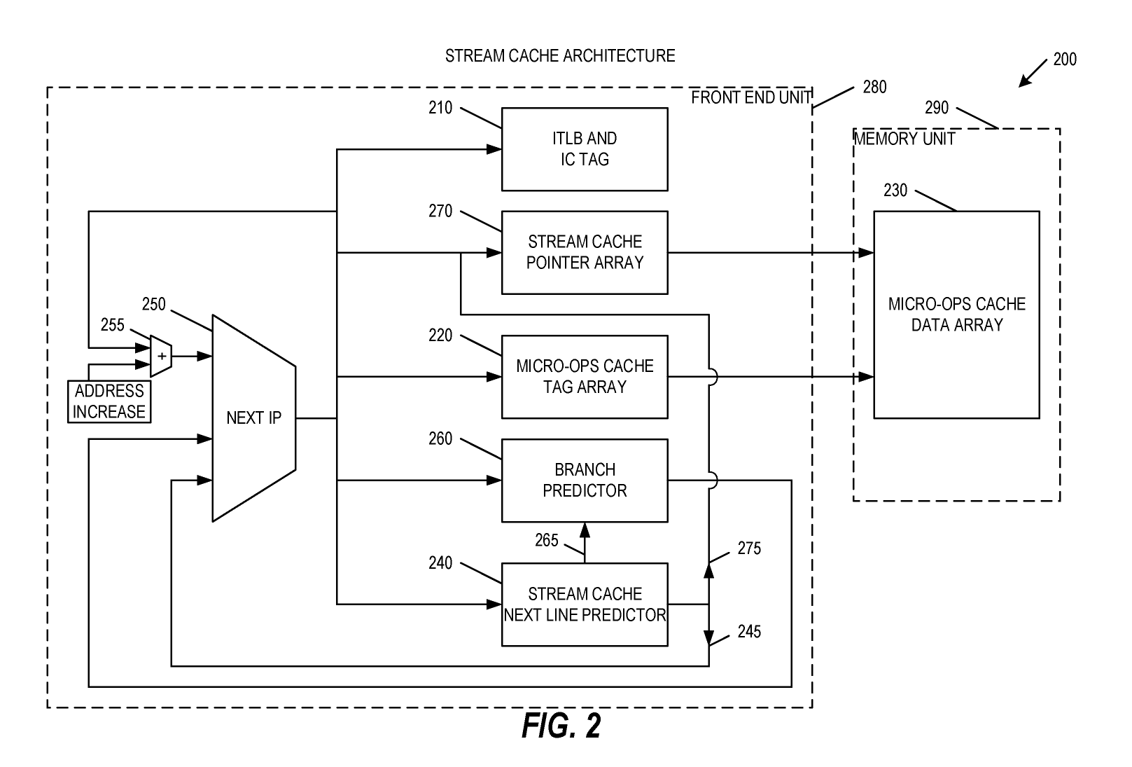

This stream fetch architecture would avoid the need for a separate identification and fetching of block B 120. This stream fetch architecture also avoids using the various hardware and software components that would otherwise be used in the separate identification and fetching of additional blocks within a longer stream of blocks, thereby saving computing operations and power required for these components. In the example shown in FIG. 1, by avoiding the need for a separate fetching of block B 120, this stream fetch architecture avoids the need for a micro-op cache, a branch prediction unit, an instruction translation lookaside buffer (TLB), or an instruction cache in fetching block B 120, such as shown in FIG. 2.

As shown in FIG. 1, the sequence of blocks may be defined by one or more jumps (e.g., branches) that are taken or not taken. A jump may include an associated destination block path and alternative block path, where the alternative block path is followed when the jump is not taken. For example, a first jump following block A 110 may lead to block J (not shown), and when that jump is not taken 112, block A 110 follows the alternative path of the jump not taken 112 to block B 120. In another example, block A 110 may be followed by a second jump taken 114 to block B 120. Similarly, block B 120 may follow a third jump not taken 122 to block C 130, or may follow a fourth jump taken 124 to block C 130. Note that other jumps may be taken or not taken to other blocks, however for the purposes of this discussion, the three blocks shown in FIG. 1 are considered to form a particular stable line though a combination of jumps taken or not taken. In an example, this stream fetch architecture provides the ability to fetch blocks across two jumps within a single fetch cycle, such as from block A 110 to block B 120 and from block B 120 to block C 130.

A stream line may be considered to be stable when there is no jump or when the jump is in a consistent direction. The jumps in a consistent direction may include an unconditional direct jump, an indirect jump that consistently takes the same target, a conditional jump that is consistently not taken, or a conditional jump that is consistently taken. Returns instructions, even when they return to a different target, are also considered stable. In an embodiment, “consistently” refers to a direction taken or not taken with a probability of 90% or more. This probability may be tuned further to provide for predicting more streams at the expense of a higher risk of misprediction. In one example, approximately ⅔ or more of fetch lines (e.g., groups of instructions) are considered to be stable. The stream cache provides improved fetching of stable lines for any processor. The fetching provided by the stream cache can be further improved by analysing the target processor or software program to improve identification and prediction of stable lines, such as using the prediction architecture shown in FIG. 2.

FIG. 2 is a block diagram illustrating a stream cache architecture 200 according to an embodiment. The stream cache architecture 200 includes a front end unit 280 and a memory unit 290. The front end unit 280 includes a next instruction protocol (IP) multiplexer 250 that identifies the address of the next fetch block (e.g., the address of the next line of code). When there is no branch (e.g., no jump), an address adder 255 increases the address to bring in the next block, such as increasing the address by 32 bytes, 64 bytes, or other address increase. When there is a branch, the branch predictor 260 takes a current address and determines the next address. The branch predictor 260 stores previously followed branches, which may be used to identify a subsequent address based on a current address. In an embodiment, the branch predictor 260 includes a one-cycle branch predictor, which may be indexed by a staged instruction pointer (staged IP).

The front end unit 280 includes a micro-operations (micro-ops) cache tag array 220 that sends memory requests (e.g., memory addresses) to a a micro-ops cache data array 230 within the memory unit 290. The cache tag array 220 and cache data array 230 may be used to store and retrieve previously fetched blocks. When a block is identified to be fetched, the cache tag array 220 and data array 230 may be used to determine whether the block had been fetched previously. If a block had been previously fetched, the cache tag array 220 and cache data array 230 may retrieve and store the block in the data array 230. If the block had not been previously fetched, then the address of the block may be retrieved within the instruction translation lookaside buffer (ITLB) and instruction cache (IC) tag 210. The ITLB and IC tag 210 may be used to store and retrieve various address translations, such as address translations that map virtual memory addresses to physical memory addresses. Retrieving a previously fetched block using micro-ops cache tag array 220 and micro-ops cache data array 230 is faster and requires less power than using the ITLB and IC tag 210 to look up a block address for subsequent retrieval.

The front end unit 280 includes a stream cache next-line-predictor (NLP) 240 to predict and fetch stable lines. In operation, the stream cache NLP 240 first identifies a stable line, such as a sequence A-B-C (e.g., block A 110, block B 120, and block C 130 shown in FIG. 1). In an embodiment, the stream cache NLP 240 includes a confidence counter, which may be used to identify the stable line of sequence A-B-C. The front end unit 280 includes a stream cache pointer array 270. The stream cache pointer array 270 provides functionality similar to that of the micro-ops cache tag array 220, including storing and retrieving addresses for blocks stored in the micro-ops cache data array 230.

Once the stream cache NLP 240 identifies the stable line sequence A-B-C, whenever it detects a fetch of A (e.g., instruction memory address A), the stream cache NLP 240 initiates separate fetching of line B. In particular, NLP 240 sends a cache instruction memory address 275 (e.g., instruction memory address B) to pointer array 270 and data array 230 to fetch B, and also sends a multiplexer instruction memory address 245 (e.g., instruction memory address C) to redirect the next instruction pointer multiplexer 250 to skip B and fetch C. As a result, when the micro-ops cache tag array 220 is providing pointers to the micro-ops cache data array 230 to fetch block A, the cache instruction memory address 275 instructs the stream cache pointer array 270 to provide pointers to the micro-ops cache data array 230 to fetch block B. By skipping the multiplexer-based fetch of B, this saves the time and power consumption usually required for a fetch of B, such as the saving time and power otherwise consumed by the ITLB and IC tag 210, the micro-ops cache tag array 220 and the branch predictor 260. Whenever the stream cache NLP 240 skips a block and fetches a different block, the NLP 240 sends a history update instruction 265 to update the branch predictor history 260 to correct history registers to reflect the block fetching history. For example, when the stream cache NLP 240 redirects the next instruction pointer multiplexer 250 to skip B and fetch C, the NLP 240 updates history registers within the branch predictor history 260 to record fetching the full sequence A-B-C.

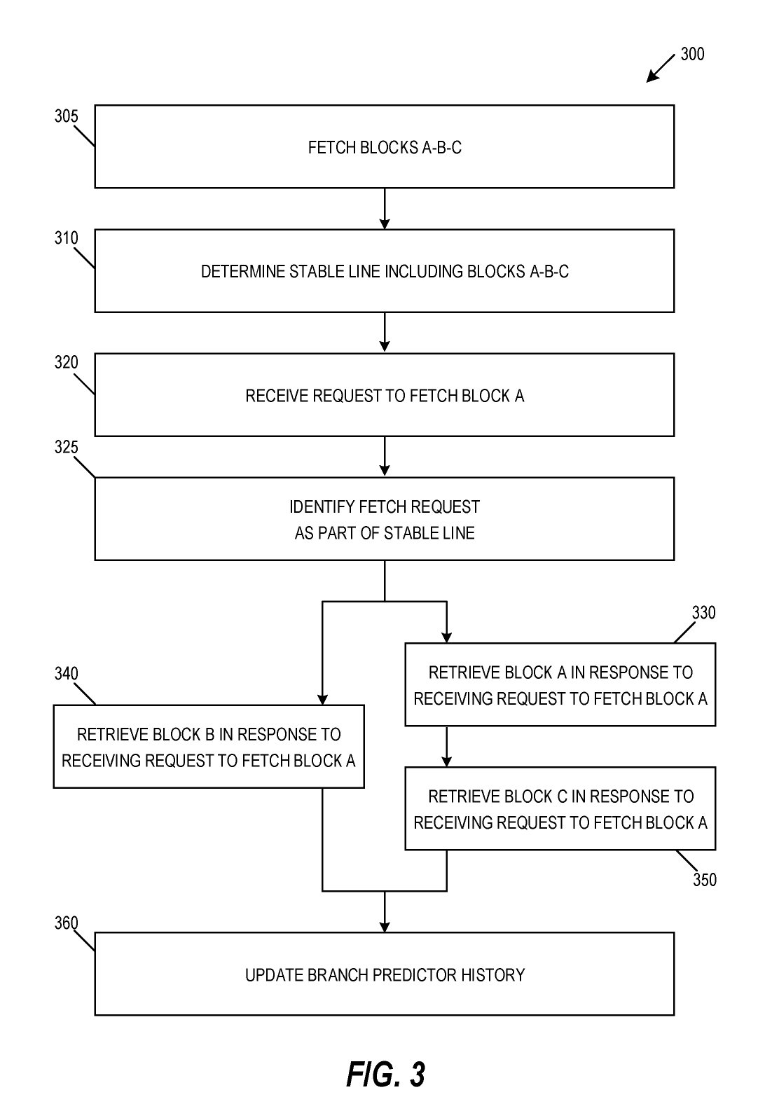

FIG. 3 is a block diagram of a stream cache method 300, in accordance with at least one embodiment. Method 300 includes fetching 305 a sequence of memory blocks A-B-C. Method 300 includes determining 310 that a stable line includes the sequence of memory blocks A-B-C. The stable line may be identified at a next line predictor based on previously received memory block addresses. The next line predictor may include a stability counter (e.g., saturated counter, confidence counter) to receive multiple memory block addresses and determine the stable line based on the received memory block addresses. The stability counter tracks each received memory request, groups sequences of memory requests into sequences, and increments a counter for each sequence. In an example, the grouping of sequences of memory requests includes tracking an entry point (e.g., entry memory address) and exit point (e.g., exit memory address) for the micro-ops cache data array 230 within memory unit 290. The counter for each sequence is reset whenever a sequence of memory requests is different from the sequence. For example, if sequence A-B-C is determined to be stable (e.g., the counter is saturated), and a memory request is received for sequence A-B-D, then the stability counter for sequence A-B-C is reset to zero, and a stability counter for sequence A-B-D is incremented.

A stability counter may be implemented for different sequences or for extensions of known sequences (e.g., multi-line stream). For example, a stability counter may be implemented for sequence A-B-C, and a separate stability counter may be implemented for sequence A-B-C-D. A stream cache fetch is performed when only one of these multi-line stream stability counters is saturated, such as a saturated sequence A-B-C-D counter resulting in a stream cache fetch of B-C and a conventional fetch of A and D. When both of these multi-line stream stability counters are saturated, then the stream cache fetch is applied only to the stream cache fetch in common, such as a stream cache fetch of B and a conventional fetch of A, C, and D. A stability counter may also be implemented for sequences that include memory block duplication. For example, memory block C may be determined to be the same as memory block A, so sequence A-B-C-D may be retrieved as A-B-A-D, such as using a stream cache fetch of B and a conventional fetch of A and D.

The stability counter for each sequence includes a saturation maximum that is selected based on increasing the likelihood of a stable line fetch while reducing the occurrence of a mistaken prediction memory flush caused by a mistaken memory sequence prediction. For example, a higher saturation maximum results in identification of fewer stable streams (e.g., reducing stream coverage), but reduces the number of mistaken memory sequence predictions. Conversely, a lower saturation maximum results in identification of more stable streams, but results in more mistaken memory sequence predictions. The saturation maximum for each sequence is selected to reduce or minimize the number of mistaken memory sequence predictions while improving stability and efficiency. The selection of the saturation maximum may be based on various tests (e.g., benchmarks) for various computing devices, computer programs, or other combinations of device hardware, firmware, and software. The selection of the saturation maximum may be selected to be a single value for all stable lines, or may be selected to be different values for each stable line. The selection of the saturation maximum may be implemented as a static value or as a dynamic value, such as a dynamic value modified during use of a computing device.

The saturation counter may be implemented using a single counter for each stable line, or may be implemented using a combination of a global counter and a stable line counter. For example, a benchmark may be used to determine that a memory sequence is determined to be a stable line after it has been fetched at least 400 times. A 9-bit counter may be used to count to 512, which provides the ability to count the stable line instances to at least 400. To reduce memory footprint, the 9-bit counter may be implemented as a 2-bit deterministic stable line counter and a 7-bit probabilistic global counter incremented on each cycle. Whenever encountering a memory sequence corresponding to a stable line, the global counter may be checked to see if it equals a predetermined value (e.g., zero), which occurs every 128 cycles (i.e., 2¹′7 cycles). When encountering a stable line memory sequence and the global counter equals the predetermined value, the 2-bit stable line counter is incremented. The combination of the 2-bit deterministic stable line counter and the 7-bit probabilistic global counter combine to provide a probabilistic 9-bit counter that is used to determine probabilistically that a stable line has been encountered at least 512 times. Other combinations of deterministic and probabilistic bit counters may be used, and may be selected based on stable line benchmark tests, available processor bit counters, expected number of stable lines, or other saturation counter considerations.

After determining 310 the stable line, method 300 includes receiving 320 a request to fetch memory block A, such as by receiving a memory address corresponding to memory block A. The request to fetch memory block A is received at both the next line predictor and a cache tag array. Based on the received request, method 300 includes identifying 325 the fetch request as a part of a stable line, such as the sequence of memory blocks A-B-C. The cache tag array causes a cache data array to retrieve 330 memory block A. The next line predictor initiates retrieving 340 of memory block B in response to the request to fetch memory block A. Retrieving 340 of memory block B may include the next line predictor instructing the cache pointer to request memory block B from the cache data array.

The next line predictor may initiate retrieving 340 of memory block B based on the stability of the sequence of memory blocks, which may be based on a saturation counter, a lack of further branching instruction, or an unconditional branching instruction. As described above, a sequence of memory blocks A-B-C may be determined when the saturation counter reaches the associated saturation maximum. The saturation counter may be used to identify a sequence of memory blocks that include conditional branching instructions yet consistently result in a fetching of the sequence of memory blocks A-B-C. Block B may also be retrieved 340 when block B has no further branching instruction. For example, a fetched sequence of memory blocks A-B may be identified when the memory requests entering and exiting the micro-ops cache data array 230 are consistent for memory blocks A-B, so the stream of memory blocks A-B is identified as stable without using a saturation counter by not having a further branching instruction. Memory block B may also be retrieved 340 when memory block B is followed by an unconditional branching instruction, such as branching instruction that always jumps to a specific target without depending on a flag or other condition. For example, a fetched memory sequence of memory blocks A-B-C may include an unconditional branching instruction from memory block B to memory block C, so a retrieval of memory block B is always followed by a retrieval of memory block C. In each of these three cases, the next line predictor provides the retrieval 340 of memory block B based on the stability of the line and in response to receiving a request 320 to fetch memory block A.

Method 300 includes retrieving 350 memory block C. Retrieving 350 memory block C may be initiated by the next line predictor in response to the request to fetch memory block A. Retrieving 350 memory block C may include the next line predictor instructing a next instruction protocol multiplexer to request memory block C, where the next instruction protocol multiplexer causes the cache tag array and cache data array to retrieve memory block C.

Method 300 includes updating 360 a branch predictor history register to reflect fetching block B. Updating 360 the branch predictor history register may include the next line predictor sending a history update instruction to the branch predictor history register to reflect retrieval of the memory block A followed by the memory block B. The branch predictor history register subsequently receives an indication of the retrieve memory block C from the next instruction protocol multiplexer, then reflecting the retrieved memory blocks as the memory block sequence A-B-C.

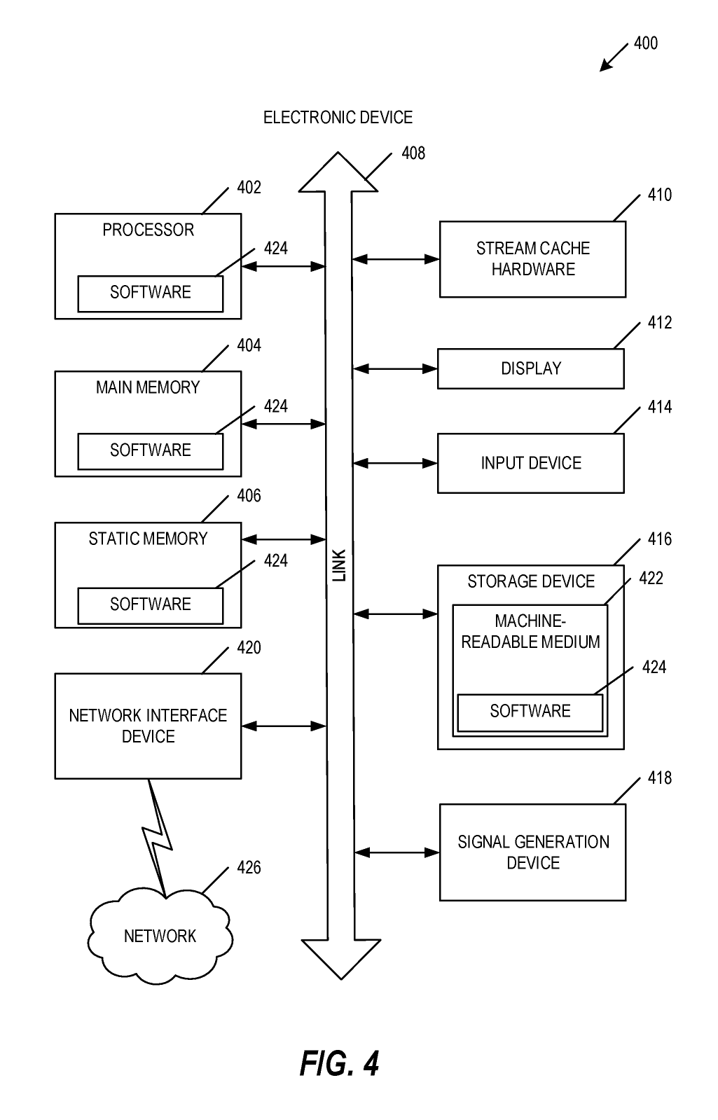

FIG. 4 is a block diagram illustrating a stream cache system in the example form of an electronic device 400, within which a set or sequence of instructions may be executed to cause the machine to perform any one of the methodologies discussed herein, according to an example embodiment. Electronic device 400 may also represent the devices shown in FIGS. 1-2. In alternative embodiments, the electronic device 400 operates as a standalone device or may be connected (e.g., networked) to other machines. In a networked deployment, the electronic device 400 may operate in the capacity of either a server or a client machine in server-client network environments, or it may act as a peer machine in peer-to-peer (or distributed) network environments. The electronic device 400 may be an integrated circuit (IC), a portable electronic device, a personal computer (PC), a tablet PC, a hybrid tablet, a personal digital assistant (PDA), a mobile telephone, or any electronic device 400 capable of executing instructions (sequential or otherwise) that specify actions to be taken by that machine to detect a user input. Further, while only a single electronic device 400 is illustrated, the terms “machine” or “electronic device” shall also be taken to include any collection of machines or devices that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to execute instructions, individually or jointly, to perform any one or more of the methodologies discussed herein.

Example electronic device 400 includes at least one processor 402 (e.g., a central processing unit (CPU), a graphics processing unit (GPU) or both, processor cores, compute nodes, etc.), a main memory 404 and a static memory 606, which communicate with each other via a link 408 (e.g., bus).

The electronic device 400 includes stream cache hardware 410, where the stream cache hardware 410 may include the components described above in FIG. 1-2. The electronic device 400 may further include a display unit 412, where the display unit 412 may include a single component that provides a user-readable display and a protective layer, or another display type. The electronic device 400 may further include an input device 414, such as a pushbutton, a keyboard, an NFC card reader, or a user interface (UI) navigation device (e.g., a touch-sensitive input). The electronic device 400 may additionally include a storage device 416, such as a solid-state drive (SSD) unit. The electronic device 400 may additionally include a signal generation device 418 to provide audible or visual feedback, such as a speaker to provide an audible feedback or one or more LEDs to provide a visual feedback. The electronic device 400 may additionally include a network interface device 420, and one or more additional sensors (not shown), such as a global positioning system (GPS) sensor, compass, accelerometer, or other sensor.

The storage device 416 includes a machine-readable medium 422 on which is stored one or more sets of data structures and instructions 424 (e.g., software) embodying or utilized by any one or more of the methodologies or functions described herein. The instructions 424 may also reside, completely or at least partially, within the main memory 404, static memory 406, and/or within the processor 402 during execution thereof by the electronic device 400. The main memory 404, static memory 406, and the processor 402 may also constitute machine-readable media.

While the machine-readable medium 422 is illustrated in an example embodiment to be a single medium, the term “machine-readable medium” may include a single medium or multiple media (e.g., a centralized or distributed database, and/or associated caches and servers) that store the one or more instructions 424. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 424 may further be transmitted or received over a communications network 426 using a transmission medium via the network interface device 420 utilizing any one of a number of well-known transfer protocols (e.g., HTTP). Examples of communication networks include a local area network (LAN), a wide area network (WAN), the Internet, mobile telephone networks, and wireless data networks (e.g., Wi-Fi, NFC, Bluetooth, Bluetooth LE, 3G, 5G LTE/LTE-A, WiMAX networks, etc.). The term “transmission medium” shall be taken to include any intangible medium that is capable of storing, encoding, or carrying instructions for execution by the machine, and includes digital or analog communications signals or other intangible medium to facilitate communication of such software.

The figures below detail exemplary architectures and systems to implement embodiments of the above. In some embodiments, one or more hardware components and/or instructions described above are emulated as detailed below, or implemented as software modules.

Embodiments of the instruction(s) detailed above are embodied may be embodied in a “generic vector friendly instruction format” which is detailed below. In other embodiments, such a format is not utilized and another instruction format is used, however, the description below of the writemask registers, various data transformations (swizzle, broadcast, etc.), addressing, etc. is generally applicable to the description of the embodiments of the instruction(s) above. Additionally, exemplary systems, architectures, and pipelines are detailed below. Embodiments of the instruction(s) above may be executed on such systems, architectures, and pipelines, but are not limited to those detailed.

An instruction set may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down though the definition of instruction templates (or subformats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. A set of SIMD extensions referred to as the Advanced Vector Extensions (AVX) (AVX1 and AVX2) and using the Vector Extensions (VEX) coding scheme has been released and/or published (e.g., see Intel® 64 and IA-32 Architectures Software Developer's Manual, September 2014; and see Intel® Advanced Vector Extensions Programming Reference, October 2014).

### Exemplary Instruction Formats

Embodiments of the instruction(s) described herein may be embodied in different formats. Additionally, exemplary systems, architectures, and pipelines are detailed below. Embodiments of the instruction(s) may be executed on such systems, architectures, and pipelines, but are not limited to those detailed.

### Generic Vector Friendly Instruction Format

A vector friendly instruction format is an instruction format that is suited for vector instructions (e.g., there are certain fields specific to vector operations). While embodiments are described in which both vector and scalar operations are supported through the vector friendly instruction format, alternative embodiments use only vector operations the vector friendly instruction format.

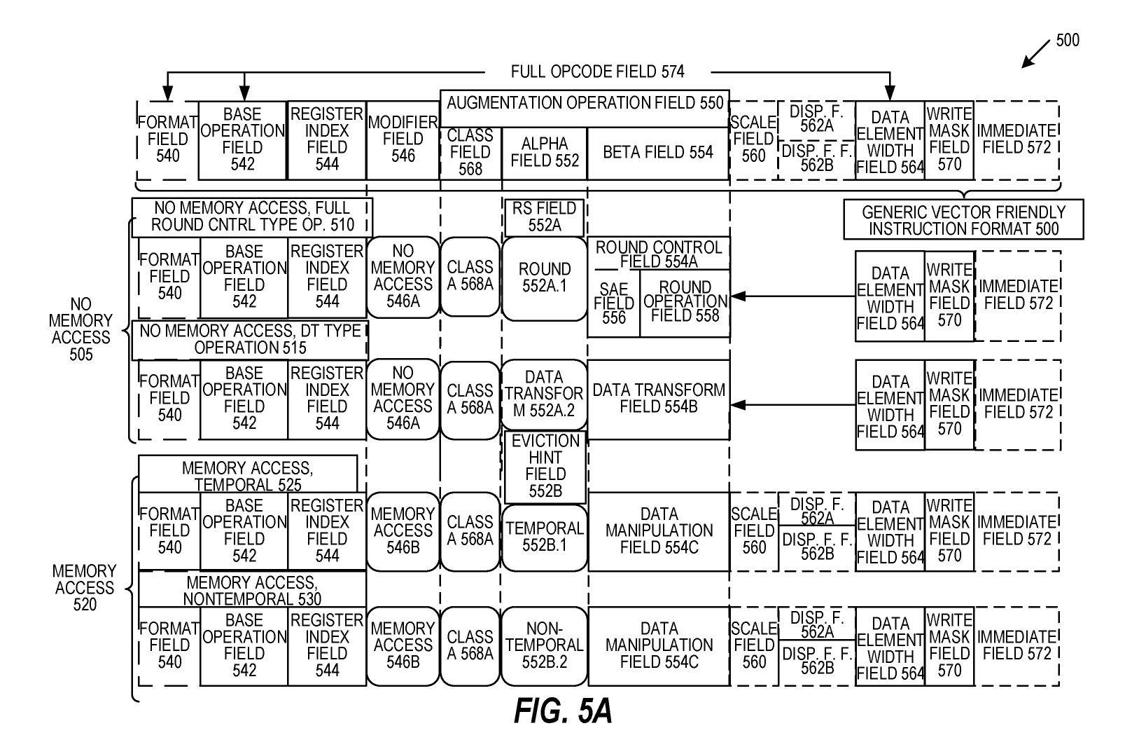

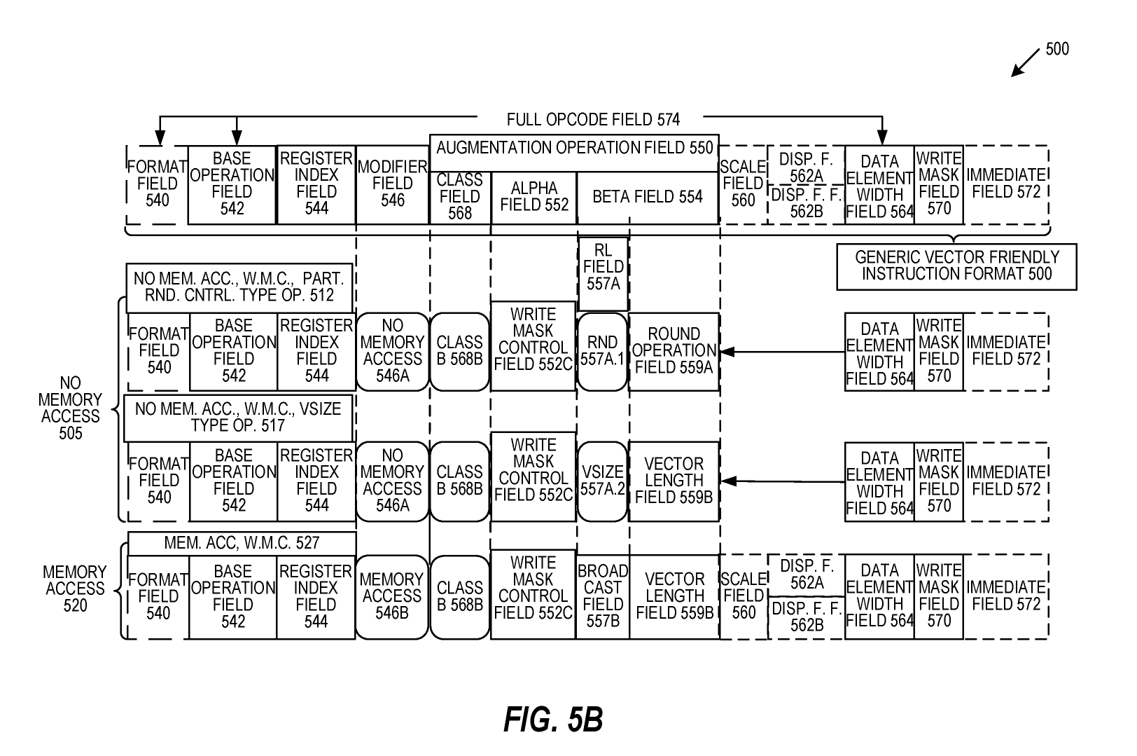

FIGS. 5A-5B are block diagrams illustrating a generic vector friendly instruction format and instruction templates thereof according to an embodiment. FIG. 5A is a block diagram illustrating a generic vector friendly instruction format and class A instruction templates thereof according to embodiments of the invention; while FIG. 5B is a block diagram illustrating the generic vector friendly instruction format and class B instruction templates thereof according to an embodiment. Specifically, a generic vector friendly instruction format 500 for which are defined class A and class B instruction templates, both of which include no memory access 505 instruction templates and memory access 520 instruction templates. The term generic in the context of the vector friendly instruction format refers to the instruction format not being tied to any specific instruction set.

While embodiments of the invention will be described in which the vector friendly instruction format supports the following: a 64 byte vector operand length (or size) with 32 bit (4 byte) or 64 bit (8 byte) data element widths (or sizes) (and thus, a 64 byte vector consists of either 16 doubleword-size elements or alternatively, 8 quadword-size elements); a 64 byte vector operand length (or size) with 16 bit (2 byte) or 8 bit (1 byte) data element widths (or sizes); a 32 byte vector operand length (or size) with 32 bit (4 byte), 64 bit (8 byte), 16 bit (2 byte), or 8 bit (1 byte) data element widths (or sizes); and a 16 byte vector operand length (or size) with 32 bit (4 byte), 64 bit (8 byte), 16 bit (2 byte), or 8 bit (1 byte) data element widths (or sizes); alternative embodiments may support more, less and/or different vector operand sizes (e.g., 256 byte vector operands) with more, less, or different data element widths (e.g., 128 bit (16 byte) data element widths).

The class A instruction templates in FIG. 5A include: 1) within the no memory access 505 instruction templates there is shown a no memory access, full round control type operation 510 instruction template and a no memory access, data transform type operation 515 instruction template; and 2) within the memory access 520 instruction templates there is shown a memory access, temporal 525 instruction template and a memory access, non-temporal 530 instruction template. The class B instruction templates in FIG. 5B include: 1) within the no memory access 505 instruction templates there is shown a no memory access, write mask control, partial round control type operation 512 instruction template and a no memory access, write mask control, VSIZE type operation 517 instruction template; and 2) within the memory access 520 instruction templates there is shown a memory access, write mask control 527 instruction template.

The generic vector friendly instruction format 500 includes the following fields listed below in the order illustrated in FIGS. 5A-5B.

Format field 540—a specific value (an instruction format identifier value) in this field uniquely identifies the vector friendly instruction format, and thus occurrences of instructions in the vector friendly instruction format in instruction streams. As such, this field is optional in the sense that it is not needed for an instruction set that has only the generic vector friendly instruction format.

Base operation field 542—its content distinguishes different base operations.

Register index field 544—its content, directly or through address generation, specifies the locations of the source and destination operands, be they in registers or in memory. These include a sufficient number of bits to select N registers from a PxQ (e.g. 32×512, 16×128, 32×1024, 64×1024) register file. While in one embodiment N may be up to three sources and one destination register, alternative embodiments may support more or less sources and destination registers (e.g., may support up to two sources where one of these sources also acts as the destination, may support up to three sources where one of these sources also acts as the destination, may support up to two sources and one destination).

Modifier field 546—its content distinguishes occurrences of instructions in the generic vector instruction format that specify memory access from those that do not; that is, between no memory access 505 instruction templates and memory access 520 instruction templates. Memory access operations read and/or write to the memory hierarchy (in some cases specifying the source and/or destination addresses using values in registers), while non-memory access operations do not (e.g., the source and destinations are registers). While in one embodiment this field also selects between three different ways to perform memory address calculations, alternative embodiments may support more, less, or different ways to perform memory address calculations.

Augmentation operation field 550—its content distinguishes which one of a variety of different operations to be performed in addition to the base operation. This field is context specific. In one embodiment of the invention, this field is divided into a class field 568, an alpha field 552, and a beta field 554. The augmentation operation field 550 allows common groups of operations to be performed in a single instruction rather than 2, 3, or 4 instructions.

Scale field 560—its content allows for the scaling of the index field's content for memory address generation (e.g., for address generation that uses 2^{scale}*index+base).

Displacement Field 562A—its content is used as part of memory address generation (e.g., for address generation that uses 2^{scale}*index+base+displacement).

Displacement Factor Field 562B (note that the juxtaposition of displacement field 562A directly over displacement factor field 562B indicates one or the other is used)—its content is used as part of address generation; it specifies a displacement factor that is to be scaled by the size of a memory access (N)—where N is the number of bytes in the memory access (e.g., for address generation that uses 2^{scale}*index+base+scaled displacement). Redundant low-order bits are ignored and hence, the displacement factor field's content is multiplied by the memory operands total size (N) in order to generate the final displacement to be used in calculating an effective address. The value of N is determined by the processor hardware at runtime based on the full opcode field 574 (described later herein) and the data manipulation field 554C. The displacement field 562A and the displacement factor field 562B are optional in the sense that they are not used for the no memory access 505 instruction templates and/or different embodiments may implement only one or none of the two.

Data element width field 564—its content distinguishes which one of a number of data element widths is to be used (in some embodiments for all instructions; in other embodiments for only some of the instructions). This field is optional in the sense that it is not needed if only one data element width is supported and/or data element widths are supported using some aspect of the opcodes.

Write mask field 570—its content controls, on a per data element position basis, whether that data element position in the destination vector operand reflects the result of the base operation and augmentation operation. Class A instruction templates support merging-writemasking, while class B instruction templates support both merging- and zeroing-writemasking. When merging, vector masks allow any set of elements in the destination to be protected from updates during the execution of any operation (specified by the base operation and the augmentation operation); in other one embodiment, preserving the old value of each element of the destination where the corresponding mask bit has a 0. In contrast, when zeroing vector masks allow any set of elements in the destination to be zeroed during the execution of any operation (specified by the base operation and the augmentation operation); in one embodiment, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the write mask field 570 allows for partial vector operations, including loads, stores, arithmetic, logical, etc. While embodiments of the invention are described in which the write mask field's 570 content selects one of a number of write mask registers that contains the write mask to be used (and thus the write mask field's 570 content indirectly identifies that masking to be performed), alternative embodiments instead or additional allow the mask write field's 570 content to directly specify the masking to be performed.

Immediate field 572—its content allows for the specification of an immediate. This field is optional in the sense that is it not present in an implementation of the generic vector friendly format that does not support immediate and it is not present in instructions that do not use an immediate.

Class field 568—its content distinguishes between different classes of instructions. With reference to FIGS. 5A-B, the contents of this field select between class A and class B instructions. In FIGS. 5A-B, rounded corner squares are used to indicate a specific value is present in a field (e.g., class A 568A and class B 568B for the class field 568 respectively in FIGS. 5A-B).

### Instruction Templates of Class A

In the case of the non-memory access 505 instruction templates of class A, the alpha field 552 is interpreted as an RS field 552A, whose content distinguishes which one of the different augmentation operation types are to be performed (e.g., round 552A.1 and data transform 552A.2 are respectively specified for the no memory access, round type operation 510 and the no memory access, data transform type operation 515 instruction templates), while the beta field 554 distinguishes which of the operations of the specified type is to be performed. In the no memory access 505 instruction templates, the scale field 560, the displacement field 562A, and the displacement scale filed 562B are not present.

### No-Memory Access Instruction Templates—Full Round Control Type Operation

In the no memory access full round control type operation 510 instruction template, the beta field 554 is interpreted as a round control field 554A, whose content(s) provide static rounding. While in the described embodiments of the invention the round control field 554A includes a suppress all floating point exceptions (SAE) field 556 and a round operation control field 558, alternative embodiments may support may encode both these concepts into the same field or only have one or the other of these concepts/fields (e.g., may have only the round operation control field 558).

SAE field 556—its content distinguishes whether or not to disable the exception event reporting; when the SAE field's 556 content indicates suppression is enabled, a given instruction does not report any kind of floating-point exception flag and does not raise any floating point exception handler.

Round operation control field 558—its content distinguishes which one of a group of rounding operations to perform (e.g., Round-up, Round-down, Round-towards-zero and Round-to-nearest). Thus, the round operation control field 558 allows for the changing of the rounding mode on a per instruction basis. In one embodiment of the invention where a processor includes a control register for specifying rounding modes, the round operation control field's 550 content overrides that register value.

### No Memory Access Instruction Templates—Data Transform Type Operation

In the no memory access data transform type operation 515 instruction template, the beta field 554 is interpreted as a data transform field 554B, whose content distinguishes which one of a number of data transforms is to be performed (e.g., no data transform, swizzle, broadcast).

In the case of a memory access 520 instruction template of class A, the alpha field 552 is interpreted as an eviction hint field 552B, whose content distinguishes which one of the eviction hints is to be used (in FIG. 5A, temporal 552B.1 and non-temporal 552B.2 are respectively specified for the memory access, temporal 525 instruction template and the memory access, non-temporal 530 instruction template), while the beta field 554 is interpreted as a data manipulation field 554C, whose content distinguishes which one of a number of data manipulation operations (also known as primitives) is to be performed (e.g., no manipulation; broadcast; up conversion of a source; and down conversion of a destination). The memory access 520 instruction templates include the scale field 560, and optionally the displacement field 562A or the displacement scale field 562B.

Vector memory instructions perform vector loads from and vector stores to memory, with conversion support. As with regular vector instructions, vector memory instructions transfer data from/to memory in a data element-wise fashion, with the elements that are actually transferred is dictated by the contents of the vector mask that is selected as the write mask.

### Memory Access Instruction Templates—Temporal

Temporal data is data likely to be reused soon enough to benefit from caching. This is, however, a hint, and different processors may implement it in different ways, including ignoring the hint entirely.

### Memory Access Instruction Templates—Non-Temporal

Non-temporal data is data unlikely to be reused soon enough to benefit from caching in the 1st-level cache and should be given priority for eviction. This is, however, a hint, and different processors may implement it in different ways, including ignoring the hint entirely.

### Instruction Templates of Class B

In the case of the instruction templates of class B, the alpha field 552 is interpreted as a write mask control (Z) field 552C, whose content distinguishes whether the write masking controlled by the write mask field 570 should be a merging or a zeroing.

In the case of the non-memory access 505 instruction templates of class B, part of the beta field 554 is interpreted as an RL field 557A, whose content distinguishes which one of the different augmentation operation types are to be performed (e.g., round 557A.1 and vector length (VSIZE) 557A.2 are respectively specified for the no memory access, write mask control, partial round control type operation 512 instruction template and the no memory access, write mask control, VSIZE type operation 517 instruction template), while the rest of the beta field 554 distinguishes which of the operations of the specified type is to be performed. In the no memory access 505 instruction templates, the scale field 560, the displacement field 562A, and the displacement scale filed 562B are not present.

In the no memory access, write mask control, partial round control type operation 510 instruction template, the rest of the beta field 554 is interpreted as a round operation field 559A and exception event reporting is disabled (a given instruction does not report any kind of floating-point exception flag and does not raise any floating point exception handler).

Round operation control field 559A—just as round operation control field 558, its content distinguishes which one of a group of rounding operations to perform (e.g., Round-up, Round-down, Round-towards-zero and Round-to-nearest). Thus, the round operation control field 559A allows for the changing of the rounding mode on a per instruction basis. In one embodiment of the invention where a processor includes a control register for specifying rounding modes, the round operation control field's 550 content overrides that register value.

In the no memory access, write mask control, VSIZE type operation 517 instruction template, the rest of the beta field 554 is interpreted as a vector length field 559B, whose content distinguishes which one of a number of data vector lengths is to be performed on (e.g., 128, 256, or 512 byte).

In the case of a memory access 520 instruction template of class B, part of the beta field 554 is interpreted as a broadcast field 557B, whose content distinguishes whether or not the broadcast type data manipulation operation is to be performed, while the rest of the beta field 554 is interpreted the vector length field 559B. The memory access 520 instruction templates include the scale field 560, and optionally the displacement field 562A or the displacement scale field 562B.

With regard to the generic vector friendly instruction format 500, a full opcode field 574 is shown including the format field 540, the base operation field 542, and the data element width field 564. While one embodiment is shown where the full opcode field 574 includes all of these fields, the full opcode field 574 includes less than all of these fields in embodiments that do not support all of them. The full opcode field 574 provides the operation code (opcode).

The augmentation operation field 550, the data element width field 564, and the write mask field 570 allow these features to be specified on a per instruction basis in the generic vector friendly instruction format.

The combination of write mask field and data element width field create typed instructions in that they allow the mask to be applied based on different data element widths.

The various instruction templates found within class A and class B are beneficial in different situations. In some embodiments of the invention, different processors or different cores within a processor may support only class A, only class B, or both classes. For instance, a high performance general purpose out-of-order core intended for general-purpose computing may support only class B, a core intended primarily for graphics and/or scientific (throughput) computing may support only class A, and a core intended for both may support both (of course, a core that has some mix of templates and instructions from both classes but not all templates and instructions from both classes is within the purview of the invention). Also, a single processor may include multiple cores, all of which support the same class or in which different cores support different class. For instance, in a processor with separate graphics and general purpose cores, one of the graphics cores intended primarily for graphics and/or scientific computing may support only class A, while one or more of the general purpose cores may be high performance general purpose cores with out of order execution and register renaming intended for general-purpose computing that support only class B. Another processor that does not have a separate graphics core, may include one more general purpose in-order or out-of-order cores that support both class A and class B. Of course, features from one class may also be implement in the other class in different embodiments of the invention. Programs written in a high level language are put (e.g., just in time compiled or statically compiled) into an variety of different executable forms, including: 1) a form having only instructions of the class(es) supported by the target processor for execution; or 2) a form having alternative routines written using different combinations of the instructions of all classes and having control flow code that selects the routines to execute based on the instructions supported by the processor which is currently executing the code.

### Exemplary Specific Vector Friendly Instruction Format

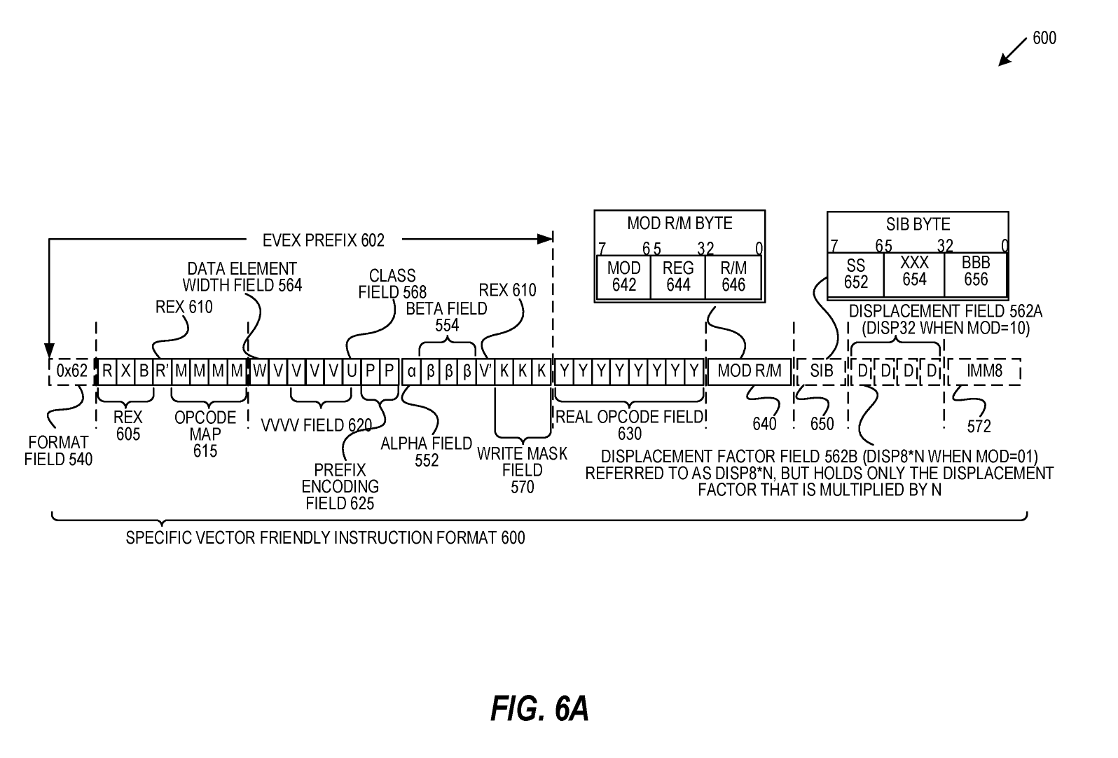

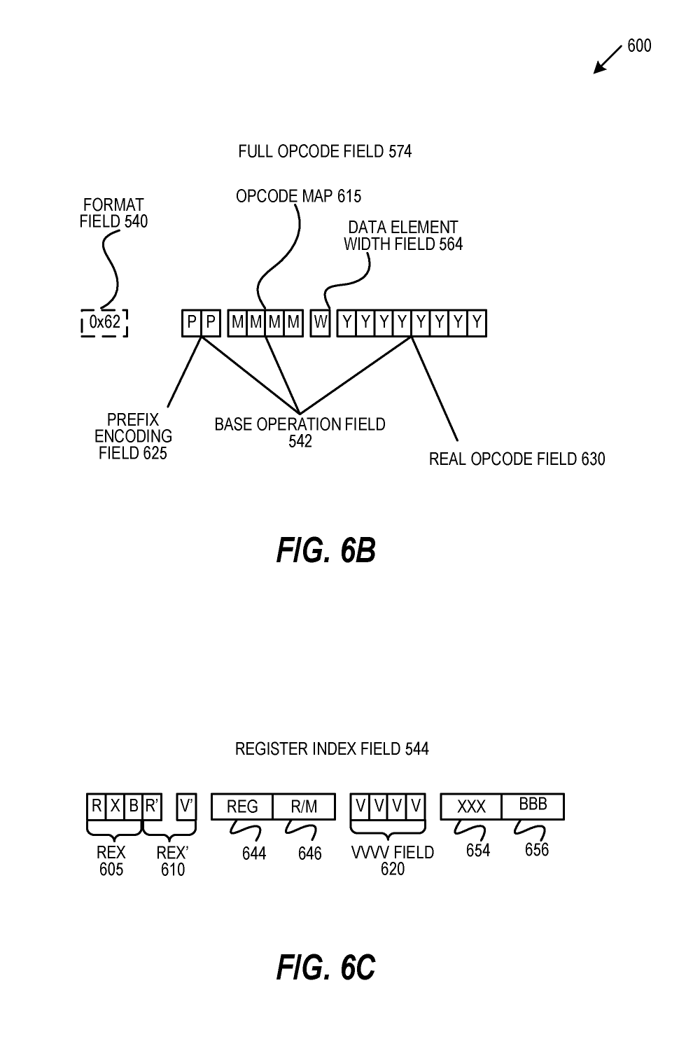

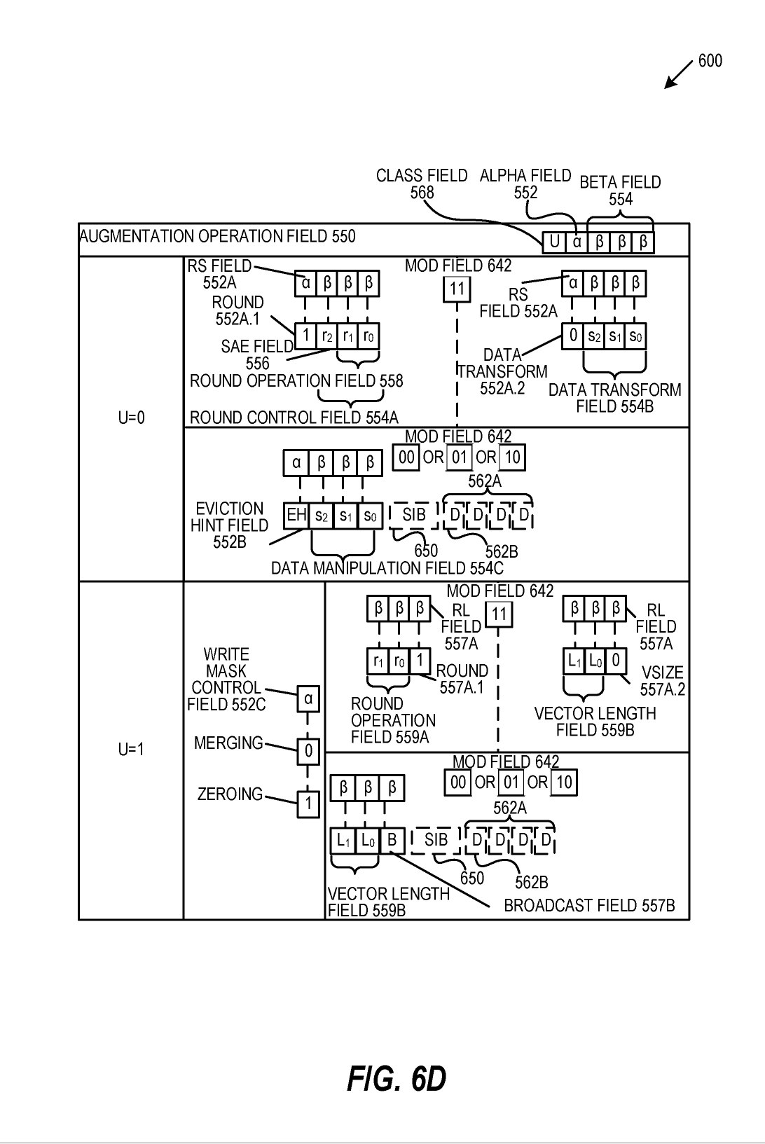

FIG. 6 is a block diagram illustrating an exemplary specific vector friendly instruction format according to an embodiment. FIG. 6 shows a specific vector friendly instruction format 600 that is specific in the sense that it specifies the location, size, interpretation, and order of the fields, as well as values for some of those fields. The specific vector friendly instruction format 600 may be used to extend the x86 instruction set, and thus some of the fields are similar or the same as those used in the existing x86 instruction set and extension thereof (e.g., AVX). This format remains consistent with the prefix encoding field, real opcode byte field, MOD R/M field, SIB field, displacement field, and immediate fields of the existing x86 instruction set with extensions. The fields from FIG. 5 into which the fields from FIG. 6 map are illustrated.

It should be understood that, although embodiments of the invention are described with reference to the specific vector friendly instruction format 600 in the context of the generic vector friendly instruction format 500 for illustrative purposes, the invention is not limited to the specific vector friendly instruction format 600 except where claimed. For example, the generic vector friendly instruction format 500 contemplates a variety of possible sizes for the various fields, while the specific vector friendly instruction format 600 is shown as having fields of specific sizes. By way of specific example, while the data element width field 564 is illustrated as a one bit field in the specific vector friendly instruction format 600, the invention is not so limited (that is, the generic vector friendly instruction format 500 contemplates other sizes of the data element width field 564).

The generic vector friendly instruction format 500 includes the following fields listed below in the order illustrated in FIG. 6A.

EVEX Prefix (Bytes 0-3) 602—is encoded in a four-byte form.

Format Field 540 (EVEX Byte 0, bits [7:0])—the first byte (EVEX Byte 0) is the format field 540 and it contains 0x62 (the unique value used for distinguishing the vector friendly instruction format in one embodiment of the invention).

The second-fourth bytes (EVEX Bytes 1-3) include a number of bit fields providing specific capability.

REX field 605 (EVEX Byte 1, bits [7-5])—consists of a EVEX.R bit field (EVEX Byte 1, bit [7]-R), EVEX.X bit field (EVEX byte 1, bit [6]-X), and 557BEX byte 1, bit[5]-B). The EVEX.R, EVEX.X, and EVEX.B bit fields provide the same functionality as the corresponding VEX bit fields, and are encoded using is complement form, i.e. ZMM0 is encoded as 1111B, ZMM15 is encoded as 0000B. Other fields of the instructions encode the lower three bits of the register indexes as is known in the art (rrr, xxx, and bbb), so that Rrrr, Xxxx, and Bbbb may be formed by adding EVEX.R, EVEX.X, and EVEX.B.

REX′ field 510—this is the first part of the REX′ field 510 and is the EVEX.R′ bit field (EVEX Byte 1, bit [4]-R′) that is used to encode either the upper 16 or lower 16 of the extended 32 register set. In one embodiment of the invention, this bit, along with others as indicated below, is stored in bit inverted format to distinguish (in the well-known x86 32-bit mode) from the BOUND instruction, whose real opcode byte is 62, but does not accept in the MOD R/M field (described below) the value of 11 in the MOD field; alternative embodiments of the invention do not store this and the other indicated bits below in the inverted format. A value of 1 is used to encode the lower 16 registers. In other words, R′Rrrr is formed by combining EVEX.R′, EVEX.R, and the other RRR from other fields.

Opcode map field 615 (EVEX byte 1, bits [3:0]-mmmm)—its content encodes an implied leading opcode byte (OF, OF 38, or OF 3).

Data element width field 564 (EVEX byte 2, bit [7]-W)—is represented by the notation EVEX.W. EVEX.W is used to define the granularity (size) of the datatype (either 32-bit data elements or 64-bit data elements).

EVEX.vvvv 620 (EVEX Byte 2, bits [6:3]-vvvv)—the role of EVEX.vvvv may include the following: 1) EVEX.vvvv encodes the first source register operand, specified in inverted (1s complement) form and is valid for instructions with 2 or more source operands; 2) EVEX.vvvv encodes the destination register operand, specified in 1s complement form for certain vector shifts; or 3) EVEX.vvvv does not encode any operand, the field is reserved and should contain 1111b. Thus, EVEX.vvvv field 620 encodes the 4 low-order bits of the first source register specifier stored in inverted (1s complement) form. Depending on the instruction, an extra different EVEX bit field is used to extend the specifier size to 32 registers.

EVEX.U 568 Class field (EVEX byte 2, bit [2]-U)—If EVEX.U=0, it indicates class A or EVEX.U0; if EVEX.U=1, it indicates class B or EVEX.U1.

Prefix encoding field 625 (EVEX byte 2, bits [1:0]-pp)—provides additional bits for the base operation field. In addition to providing support for the legacy SSE instructions in the EVEX prefix format, this also has the benefit of compacting the SIMD prefix (rather than requiring a byte to express the SIMD prefix, the EVEX prefix requires only 2 bits). In one embodiment, to support legacy SSE instructions that use a SIMD prefix (66H, F2H, F3H) in both the legacy format and in the EVEX prefix format, these legacy SIMD prefixes are encoded into the SIMD prefix encoding field; and at runtime are expanded into the legacy SIMD prefix prior to being provided to the decoder's PLA (so the PLA can execute both the legacy and EVEX format of these legacy instructions without modification). Although newer instructions could use the EVEX prefix encoding field's content directly as an opcode extension, certain embodiments expand in a similar fashion for consistency but allow for different meanings to be specified by these legacy SIMD prefixes. An alternative embodiment may redesign the PLA to support the 2 bit SIMD prefix encodings, and thus not require the expansion.

Alpha field 552 (EVEX byte 3, bit [7]-EH; also known as EVEX.EH, EVEX.rs, EVEX.RL, EVEX.write mask control, and EVEX.N; also illustrated with α)—as previously described, this field is context specific.

Beta field 554 (EVEX byte 3, bits [6:4]-SSS, also known as EVEX.s₂₋₀, EVEX.r₂₋₀, EVEX.rr1, EVEX.LL0, EVEX.LLB; also illustrated with βββ)—as previously described, this field is context specific.

REX′ field 510—this is the remainder of the REX′ field and is the EVEX.V′ bit field (EVEX Byte 3, bit [3]-V′) that may be used to encode either the upper 16 or lower 16 of the extended 32 register set. This bit is stored in bit inverted format. A value of 1 is used to encode the lower 16 registers. In other words, V′VVVV is formed by combining EVEX.V′, EVEX.vvvv.

Write mask field 570 (EVEX byte 3, bits [2:0]-kkk)—its content specifies the index of a register in the write mask registers as previously described. In one embodiment of the invention, the specific value EVEX.kkk=000 has a special behavior implying no write mask is used for the particular instruction (this may be implemented in a variety of ways including the use of a write mask hardwired to all ones or hardware that bypasses the masking hardware).

Real Opcode Field 630 (Byte 4) is also known as the opcode byte. Part of the opcode is specified in this field.

MOD R/M Field 640 (Byte 5) includes MOD field 642, Reg field 644, and R/M field 646. As previously described, the MOD field's 642 content distinguishes between memory access and non-memory access operations. The role of Reg field 644 can be summarized to two situations: encoding either the destination register operand or a source register operand, or be treated as an opcode extension and not used to encode any instruction operand. The role of RIM field 646 may include the following: encoding the instruction operand that references a memory address, or encoding either the destination register operand or a source register operand.

Scale, Index, Base (SIB) Byte (Byte 6)—As previously described, the scale field's 550 content is used for memory address generation. SIB.xxx 654 and SIB.bbb 656—the contents of these fields have been previously referred to with regard to the register indexes Xxxx and Bbbb.

Displacement field 562A (Bytes 7-10)—when MOD field 642 contains 10, bytes 7-10 are the displacement field 562A, and it works the same as the legacy 32-bit displacement (disp32) and works at byte granularity.

Displacement factor field 562B (Byte 7)—when MOD field 642 contains 01, byte 7 is the displacement factor field 562B. The location of this field is that same as that of the legacy x86 instruction set 8-bit displacement (disp8), which works at byte granularity. Since disp8 is sign extended, it can only address between −128 and 127 bytes offsets; in terms of 64 byte cache lines, disp8 uses 8 bits that can be set to only four really useful values −128, −64, 0, and 64; since a greater range is often needed, disp32 is used; however, disp32 requires 4 bytes. In contrast to disp8 and disp32, the displacement factor field 562B is a reinterpretation of disp8; when using displacement factor field 562B, the actual displacement is determined by the content of the displacement factor field multiplied by the size of the memory operand access (N). This type of displacement is referred to as disp8*N. This reduces the average instruction length (a single byte of used for the displacement but with a much greater range). Such compressed displacement is based on the assumption that the effective displacement is multiple of the granularity of the memory access, and hence, the redundant low-order bits of the address offset do not need to be encoded. In other words, the displacement factor field 562B substitutes the legacy x86 instruction set 8-bit displacement. Thus, the displacement factor field 562B is encoded the same way as an x86 instruction set 8-bit displacement (so no changes in the ModRM/SIB encoding rules) with the only exception that disp8 is overloaded to disp8*N. In other words, there are no changes in the encoding rules or encoding lengths but only in the interpretation of the displacement value by hardware (which needs to scale the displacement by the size of the memory operand to obtain a byte-wise address offset). Immediate field 572 operates as previously described.

### Full Opcode Field

FIG. 6B is a block diagram illustrating the fields of the specific vector friendly instruction format 600 that make up the full opcode field 574 according to one embodiment of the invention. Specifically, the full opcode field 574 includes the format field 540, the base operation field 542, and the data element width (W) field 564. The base operation field 542 includes the prefix encoding field 625, the opcode map field 615, and the real opcode field 630.

### Register Index Field

FIG. 6C is a block diagram illustrating the fields of the specific vector friendly instruction format 600 that make up the register index field 544 according to one embodiment of the invention. Specifically, the register index field 544 includes the REX field 605, the REX′ field 610, the MODR/M.reg field 644, the MODR/M.r/m field 646, the VVVV field 620, xxx field 654, and the bbb field 656.

### Augmentation Operation Field

FIG. 6D is a block diagram illustrating the fields of the specific vector friendly instruction format 600 that make up the augmentation operation field 550 according to one embodiment of the invention. When the class (U) field 568 contains 0, it signifies EVEX.U0 (class A 568A); when it contains 1, it signifies EVEX.U1 (class B 568B). When U=0 and the MOD field 642 contains 11 (signifying a no memory access operation), the alpha field 552 (EVEX byte 3, bit [7]-EH) is interpreted as the rs field 552A. When the rs field 552A contains a 1 (round 552A.1), the beta field 554 (EVEX byte 3, bits [6:4]-SSS) is interpreted as the round control field 554A. The round control field 554A includes a one bit SAE field 556 and a two bit round operation field 558. When the rs field 552A contains a 0 (data transform 552A.2), the beta field 554 (EVEX byte 3, bits [6:4]-SSS) is interpreted as a three bit data transform field 554B. When U=0 and the MOD field 642 contains 00, 01, or 10 (signifying a memory access operation), the alpha field 552 (EVEX byte 3, bit [7]-EH) is interpreted as the eviction hint (EH) field 552B and the beta field 554 (EVEX byte 3, bits [6:4]-SSS) is interpreted as a three bit data manipulation field 554C.

When U=1, the alpha field 552 (EVEX byte 3, bit [7]-EH) is interpreted as the write mask control (Z) field 552C. When U=1 and the MOD field 642 contains 11 (signifying a no memory access operation), part of the beta field 554 (EVEX byte 3, bit [4]-S0) is interpreted as the RL field 557A; when it contains a 1 (round 557A.1) the rest of the beta field 554 (EVEX byte 3, bit [6-5]-S2-1) is interpreted as the round operation field 559A, while when the RL field 557A contains a 0 (VSIZE 557.A2) the rest of the beta field 554 (EVEX byte 3, bit [6-5]-S2-1) is interpreted as the vector length field 559B (EVEX byte 3, bit [6-5]-L1-0). When U=1 and the MOD field 642 contains 00, 01, or 10 (signifying a memory access operation), the beta field 554 (EVEX byte 3, bits [6:4]-SSS) is interpreted as the vector length field 559B (EVEX byte 3, bit [6-5]-L1-0) and the broadcast field 557B (EVEX byte 3, bit [4]-B).

### Exemplary Register Architecture

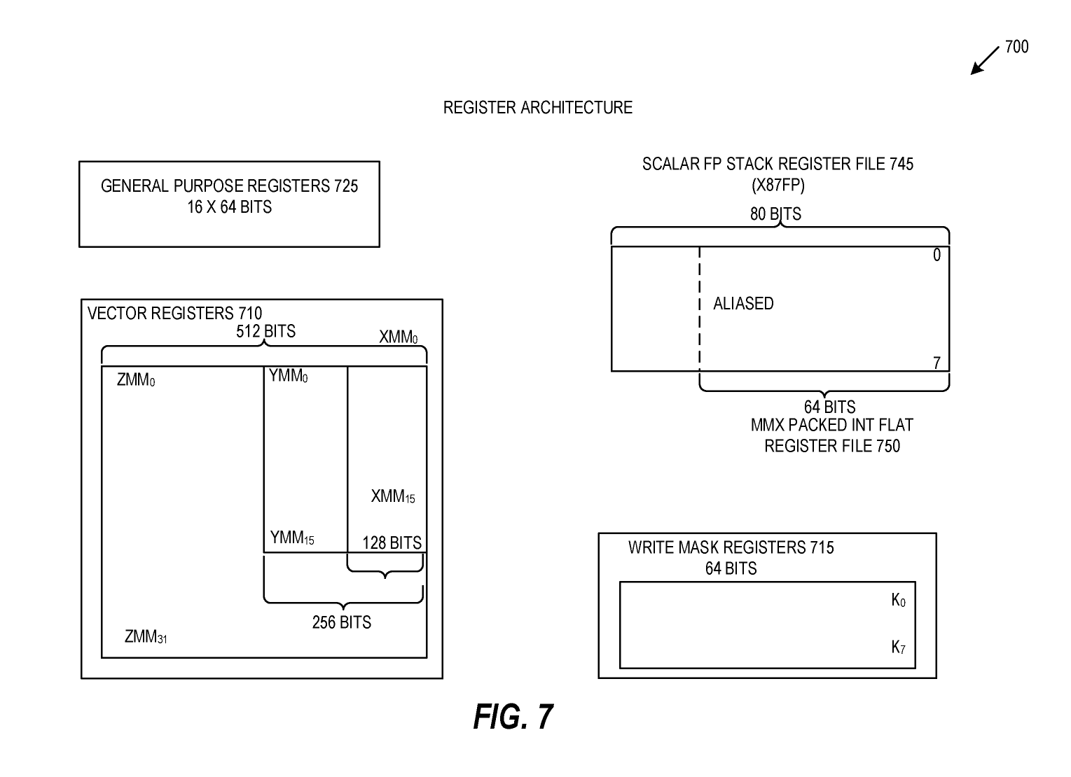

FIG. 7 is a block diagram of a register architecture 700 according to one embodiment of the invention. In the embodiment illustrated, there are 32 vector registers 710 that are 512 bits wide; these registers are referenced as zmm0 through zmm31. The lower order 256 bits of the lower 16 zmm registers are overlaid on registers ymm0-16. The lower order 128 bits of the lower 16 zmm registers (the lower order 128 bits of the ymm registers) are overlaid on registers xmm0-15. The specific vector friendly instruction format 600 operates on these overlaid register file as illustrated in the below tables.

| Adjustable Vector | | | |
|---|---|---|---|
| Length | Class | Operations | Registers |
| Instruction | A (FIG. | 510, 515, | zmm registers (the vector |
| Templates that do | 5A; U = 0) | 525, 530 | length is 64 byte) |
| not include the | B (FIG. | 512 | zmm registers (the vector |
| vector length field | 5B; U = 1) | | length is 64 byte) |
| 559B | | | |
| Instruction | B (FIG. | 517, 527 | zmm, ymm, or xmm |
| templates that do | 5B; U = 1) | | registers (the vector length |
| include the vector | | | is 64 byte, 32 byte, or 16 |
| length field 559B | | | byte) depending on the |
| | | | vector length field 559B |

In other words, the vector length field 559B selects between a maximum length and one or more other shorter lengths, where each such shorter length is half the length of the preceding length; and instructions templates without the vector length field 559B operate on the maximum vector length. Further, in one embodiment, the class B instruction templates of the specific vector friendly instruction format 600 operate on packed or scalar single/double-precision floating point data and packed or scalar integer data. Scalar operations are operations performed on the lowest order data element position in an zmm/ymm/xmm register; the higher order data element positions are either left the same as they were prior to the instruction or zeroed depending on the embodiment.

Write mask registers 715—in the embodiment illustrated, there are 8 write mask registers (k0 through k7), each 64 bits in size. In an alternate embodiment, the write mask registers 715 are 16 bits in size. As previously described, in one embodiment of the invention, the vector mask register k0 cannot be used as a write mask; when the encoding that would normally indicate k0 is used for a write mask, it selects a hardwired write mask of 0xFFFF, effectively disabling write masking for that instruction.

General-purpose registers 725—in the embodiment illustrated, there are sixteen 64-bit general-purpose registers that are used along with the existing x86 addressing modes to address memory operands. These registers are referenced by the names RAX, RBX, RCX, RDX, RBP, RSI, RDI, RSP, and R8 through R15.

Scalar floating point stack register file (x87 stack) 745, on which is aliased the MMX packed integer flat register file 750—in the embodiment illustrated, the x87 stack is an eight-element stack used to perform scalar floating-point operations on 32/64/80-bit floating point data using the x87 instruction set extension; while the MMX registers are used to perform operations on 64-bit packed integer data, as well as to hold operands for some operations performed between the MMX and XMM registers.

Alternative embodiments of the invention may use wider or narrower registers. Additionally, alternative embodiments of the invention may use more, less, or different register files and registers.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

### Exemplary Core Architectures: In-Order and Out-of-Order Core Block Diagram

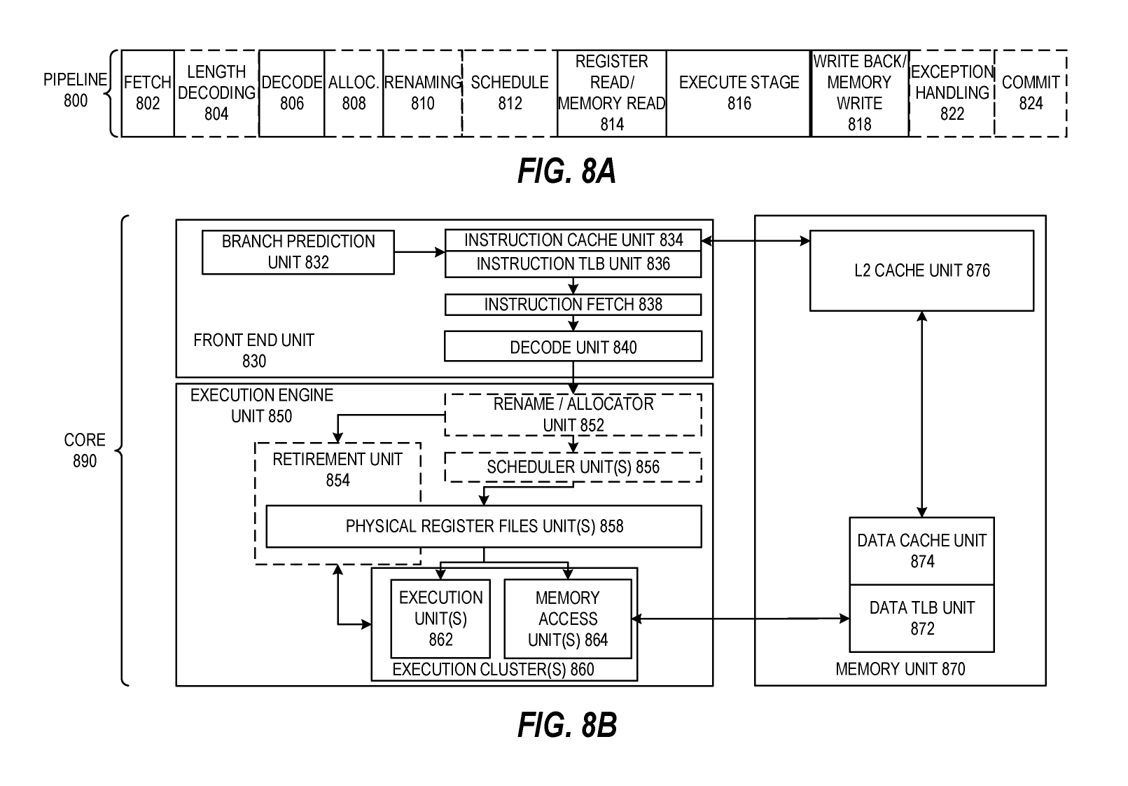

FIG. 8A is a block diagram illustrating both an exemplary in-order pipeline and an exemplary register renaming, out-of-order issue/execution pipeline according to an embodiment. FIG. 8B is a block diagram illustrating both an exemplary embodiment of an in-order architecture core and an exemplary register renaming, out-of-order issue/execution architecture core to be included in a processor according to an embodiment. The solid lined boxes in FIGS. 8A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 8A, a processor pipeline 800 includes a fetch stage 802, a length decode stage 804, a decode stage 806, an allocation stage 808, a renaming stage 810, a scheduling (also known as a dispatch or issue) stage 812, a register read/memory read stage 814, an execute stage 816, a write back/memory write stage 818, an exception handling stage 822, and a commit stage 824.

FIG. 8B shows processor core 890 including a front end unit 830 coupled to an execution engine unit 850, and both are coupled to a memory unit 870. The core 890 may be a reduced instruction set computing (RISC) core, a complex instruction set computing (CISC) core, a very long instruction word (VLIW) core, or a hybrid or alternative core type. As yet another option, the core 890 may be a special-purpose core, such as, for example, a network or communication core, compression engine, coprocessor core, general purpose computing graphics processing unit (GPGPU) core, graphics core, or the like.

The front end unit 830 may include one or more of the circuits or other structures described with respect to the front-end unit 280 in FIG. 2. The front end unit 830 includes a branch prediction unit 832 coupled to an instruction cache unit 834, which is coupled to an instruction translation lookaside buffer (TLB) 836, which is coupled to an instruction fetch unit 838, which is coupled to a decode unit 840. The decode unit 840 (or decoder) may decode instructions, and generate as an output one or more micro-operations, micro-code entry points, microinstructions, other instructions, or other control signals, which are decoded from, or which otherwise reflect, or are derived from, the original instructions. The decode unit 840 may be implemented using various different mechanisms. Examples of suitable mechanisms include, but are not limited to, look-up tables, hardware implementations, programmable logic arrays (PLAs), microcode read only memories (ROMs), etc. In one embodiment, the core 890 includes a microcode ROM or other medium that stores microcode for certain macroinstructions (e.g., in decode unit 840 or otherwise within the front end unit 830). The decode unit 840 is coupled to a rename/allocator unit 852 in the execution engine unit 850.

The execution engine unit 850 includes the rename/allocator unit 852 coupled to a retirement unit 854 and a set of one or more scheduler unit(s) 856. The scheduler unit(s) 856 represents any number of different schedulers, including reservations stations, central instruction window, etc. The scheduler unit(s) 856 is coupled to the physical register file(s) unit(s) 858. Each of the physical register file(s) units 858 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 858 comprises a vector registers unit, a write mask registers unit, and a scalar registers unit. These register units may provide architectural vector registers, vector mask registers, and general purpose registers. The physical register file(s) unit(s) 858 is overlapped by the retirement unit 854 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 854 and the physical register file(s) unit(s) 858 are coupled to the execution cluster(s) 860. The execution cluster(s) 860 includes a set of one or more execution units 862 and a set of one or more memory access units 864. The execution units 862 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 856, physical register file(s) unit(s) 858, and execution cluster(s) 860 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 864). It should also be understood that where separate pipelines are used, one or more of these pipelines may be out-of-order issue/execution and the rest in-order.

The memory unit 870 may include one or more of the circuits or other structures described with respect to the memory unit 290 in FIG. 2. The set of memory access units 864 is coupled to the memory unit 870, which includes a data TLB unit 872 coupled to a data cache unit 874 coupled to a level 2 (L2) cache unit 876. In one exemplary embodiment, the memory access units 864 may include a load unit, a store address unit, and a store data unit, each of which is coupled to the data TLB unit 872 in the memory unit 870. The instruction cache unit 834 is further coupled to a level 2 (L2) cache unit 876 in the memory unit 870. The L2 cache unit 876 is coupled to one or more other levels of cache and eventually to a main memory.

By way of example, the exemplary register renaming, out-of-order issue/execution core architecture may implement the pipeline 800 as follows: 1) the instruction fetch 838 performs the fetch and length decoding stages 802 and 804; 2) the decode unit 840 performs the decode stage 806; 3) the rename/allocator unit 852 performs the allocation stage 808 and renaming stage 810; 4) the scheduler unit(s) 856 performs the schedule stage 812; 5) the physical register file(s) unit(s) 858 and the memory unit 870 perform the register read/memory read stage 814; the execution cluster 860 perform the execute stage 816; 6) the memory unit 870 and the physical register file(s) unit(s) 858 perform the write back/memory write stage 818; 7) various units may be involved in the exception handling stage 822; and 8) the retirement unit 854 and the physical register file(s) unit(s) 858 perform the commit stage 824.

The core 890 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 890 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 834/874 and a shared L2 cache unit 876, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

### Specific Exemplary In-Order Core Architecture

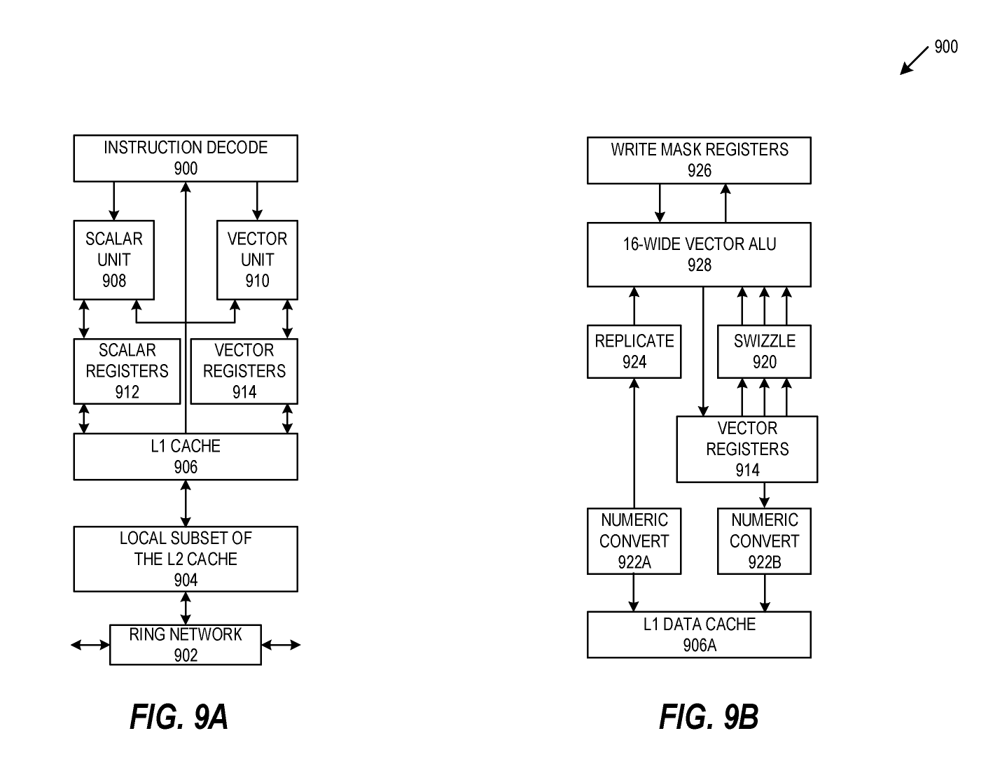

FIGS. 9A-9B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 9A is a block diagram of a single processor core, along with its connection to the on-die interconnect network 902 and with its local subset of the Level 2 (L2) cache 904, according to an embodiment. In one embodiment, an instruction decoder 900 supports the x86 instruction set with a packed data instruction set extension. An L1 cache 906 allows low-latency accesses to cache memory into the scalar and vector units. While in one embodiment (to simplify the design), a scalar unit 908 and a vector unit 910 use separate register sets (respectively, scalar registers 912 and vector registers 914) and data transferred between them is written to memory and then read back in from a level 1 (L1) cache 906, alternative embodiments of the invention may use a different approach (e.g., use a single register set or include a communication path that allow data to be transferred between the two register files without being written and read back).

The local subset of the L2 cache 904 is part of a global L2 cache that is divided into separate local subsets, one per processor core. Each processor core has a direct access path to its own local subset of the L2 cache 904. Data read by a processor core is stored in its L2 cache subset 904 and can be accessed quickly, in parallel with other processor cores accessing their own local L2 cache subsets. Data written by a processor core is stored in its own L2 cache subset 904 and is flushed from other subsets, if necessary. The ring network ensures coherency for shared data. The ring network is bi-directional to allow agents such as processor cores, L2 caches and other logic blocks to communicate with each other within the chip. Each ring data-path is 1012-bits wide per direction.

FIG. 9B is an expanded view of part of the processor core in FIG. 9A according to an embodiment. FIG. 9B includes an L1 data cache 906A part of the L1 cache 904, as well as more detail regarding the vector unit 910 and the vector registers 914. Specifically, the vector unit 910 is a 16-wide vector processing unit (VPU) (see the 16-wide ALU 928), which executes one or more of integer, single-precision float, and double-precision float instructions. The VPU supports swizzling the register inputs with swizzle unit 920, numeric conversion with numeric convert units 922A-B, and replication with replication unit 924 on the memory input. Write mask registers 926 allow predicating resulting vector writes.

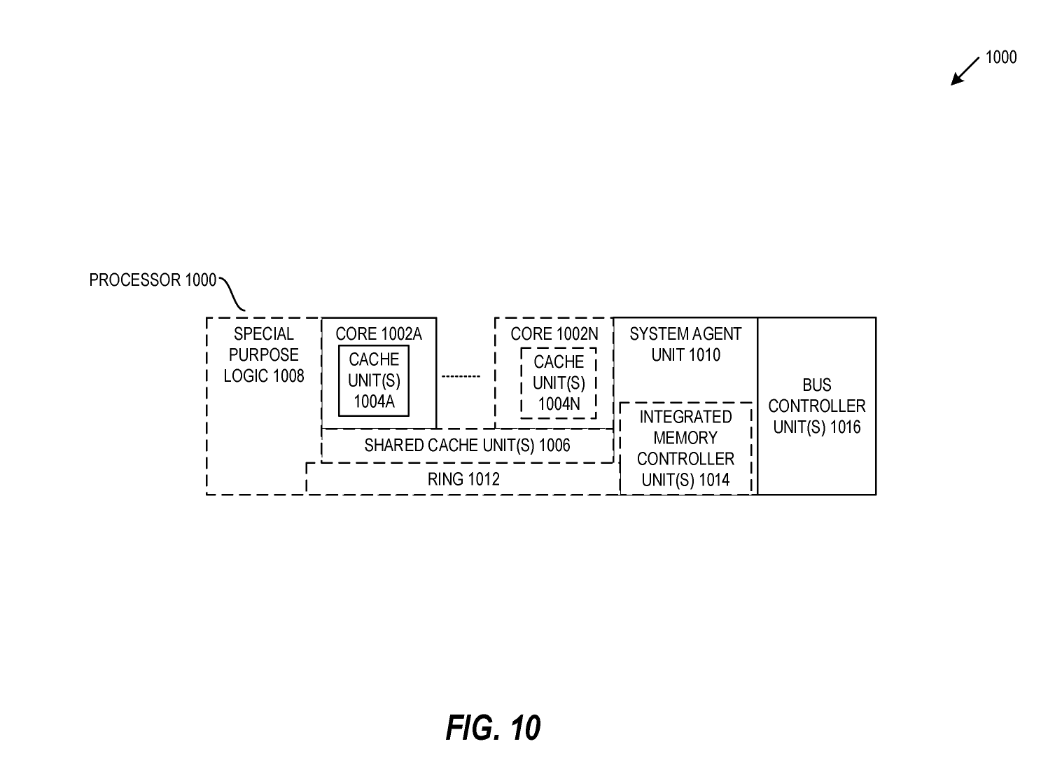

FIG. 10 is a block diagram of a processor 1000 that may have more than one core, may have an integrated memory controller, and may have integrated graphics according to an embodiment. The solid lined boxes in FIG. 10 illustrate a processor 1000 with a single core 1002A, a system agent 1010, a set of one or more bus controller units 1016, while the optional addition of the dashed lined boxes illustrates an alternative processor 1000 with multiple cores 1002A-N, a set of one or more integrated memory controller unit(s) 1014 in the system agent unit 1010, and special purpose logic 1008.

Thus, different implementations of the processor 1000 may include: 1) a CPU with the special purpose logic 1008 being integrated graphics and/or scientific (throughput) logic (which may include one or more cores), and the cores 1002A-N being one or more general purpose cores (e.g., general purpose in-order cores, general purpose out-of-order cores, a combination of the two); 2) a coprocessor with the cores 1002A-N being a large number of special purpose cores intended primarily for graphics and/or scientific (throughput); and 3) a coprocessor with the cores 1002A-N being a large number of general purpose in-order cores. Thus, the processor 1000 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 1000 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 1006, and external memory (not shown) coupled to the set of integrated memory controller units 1014. The set of shared cache units 1006 may include one or more mid-level caches, such as level 2 (L2), level 3 (L3), level 4 (L4), or other levels of cache, a last level cache (LLC), and/or combinations thereof. While in one embodiment a ring based interconnect unit 1012 interconnects the integrated graphics logic 1008, the set of shared cache units 1006, and the system agent unit 1010/integrated memory controller unit(s) 1014, alternative embodiments may use any number of well-known techniques for interconnecting such units. In one embodiment, coherency is maintained between one or more cache units 1006 and cores 1002-A-N.

In some embodiments, one or more of the cores 1002A-N are capable of multi-threading. The system agent 1010 includes those components coordinating and operating cores 1002A-N. The system agent unit 1010 may include for example a power control unit (PCU) and a display unit. The PCU may be or include logic and components needed for regulating the power state of the cores 1002A-N and the integrated graphics logic 1008. The display unit is for driving one or more externally connected displays.

The cores 1002A-N may be homogenous or heterogeneous in terms of architecture instruction set; that is, two or more of the cores 1002A-N may be capable of execution the same instruction set, while others may be capable of executing only a subset of that instruction set or a different instruction set.

### Exemplary Computer Architectures

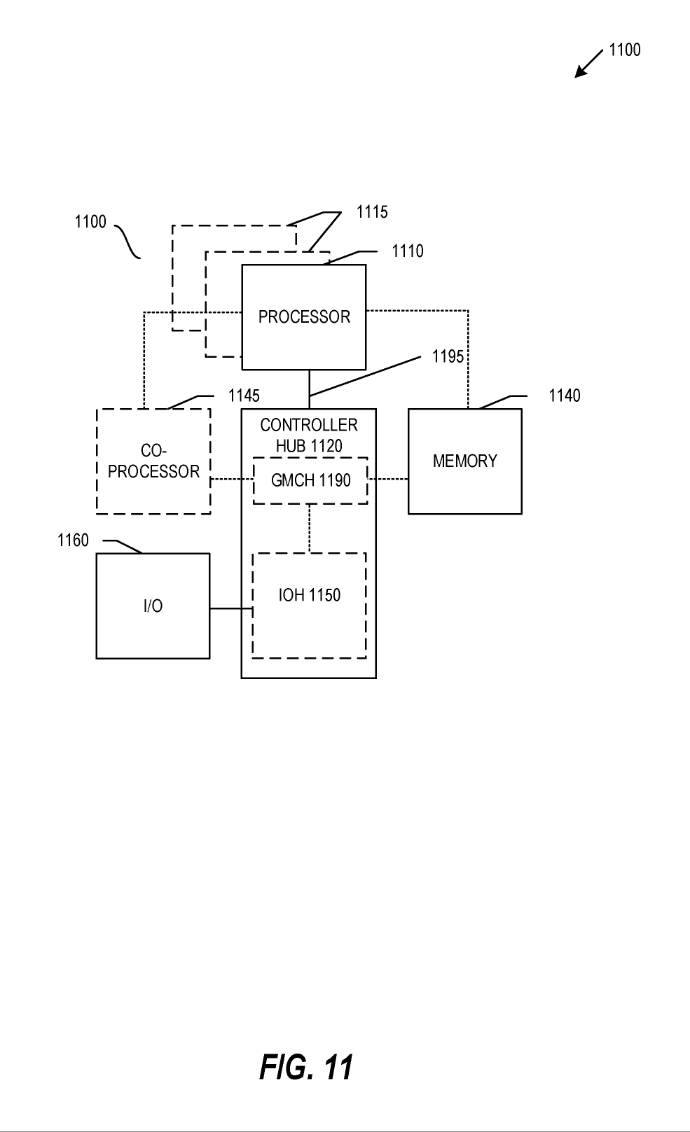

FIGS. 11-14 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 11, shown is a block diagram of a system 1100 in accordance with one embodiment of the present invention. The system 1100 may include one or more processors 1110, 1115, which are coupled to a controller hub 1120. In one embodiment the controller hub 1120 includes a graphics memory controller hub (GMCH) 1190 and an Input/Output Hub (IOH) 1150 (which may be on separate chips); the GMCH 1190 includes memory and graphics controllers to which are coupled memory 1140 and a coprocessor 1145; the IOH 1150 is couples input/output (I/O) devices 1160 to the GMCH 1190. Alternatively, one or both of the memory and graphics controllers are integrated within the processor (as described herein), the memory 1140 and the coprocessor 1145 are coupled directly to the processor 1110, and the controller hub 1120 in a single chip with the IOH 1150.

The optional nature of additional processors 1115 is denoted in FIG. 11 with broken lines. Each processor 1110, 1115 may include one or more of the processing cores described herein and may be some version of the processor 1000.

The memory 1140 may be, for example, dynamic random access memory (DRAM), phase change memory (PCM), or a combination of the two. For at least one embodiment, the controller hub 1120 communicates with the processor(s) 1110, 1115 via a multi-drop bus, such as a frontside bus (FSB), point-to-point interface such as QuickPath Interconnect (QPI), or similar connection 1195.

In one embodiment, the coprocessor 1145 is a special-purpose processor, such as, for example, a high-throughput MIC processor, a network or communication processor, compression engine, graphics processor, GPGPU, embedded processor, or the like. In one embodiment, controller hub 1120 may include an integrated graphics accelerator.

There can be a variety of differences between the physical resources 1110, 1115 in terms of a spectrum of metrics of merit including architectural, microarchitectural, thermal, power consumption characteristics, and the like.

In one embodiment, the processor 1110 executes instructions that control data processing operations of a general type. Embedded within the instructions may be coprocessor instructions. The processor 1110 recognizes these coprocessor instructions as being of a type that should be executed by the attached coprocessor 1145. Accordingly, the processor 1110 issues these coprocessor instructions (or control signals representing coprocessor instructions) on a coprocessor bus or other interconnect, to coprocessor 1145. Coprocessor(s) 1145 accept and execute the received coprocessor instructions.

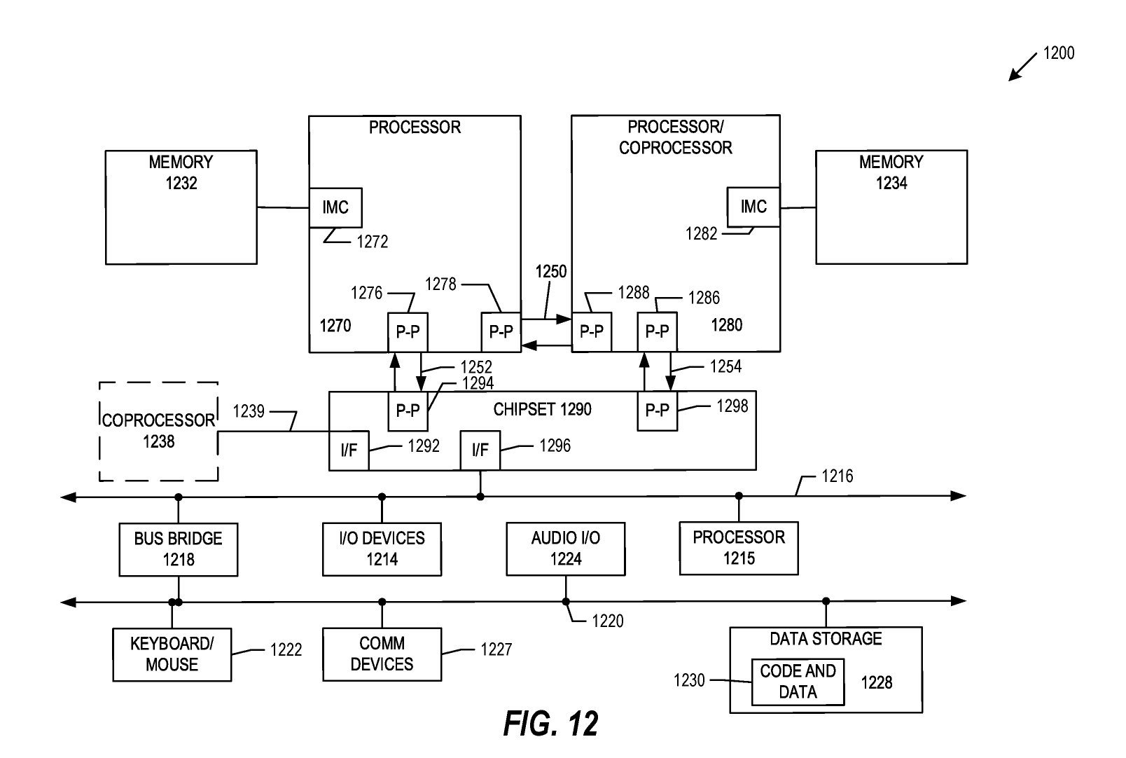

Referring now to FIG. 12, shown is a block diagram of a first more specific exemplary system 1200 in accordance with an embodiment of the present invention. As shown in FIG. 12, multiprocessor system 1200 is a point-to-point interconnect system, and includes a first processor 1270 and a second processor 1280 coupled via a point-to-point interconnect 1250. Each of processors 1270 and 1280 may be some version of the processor 1000. In one embodiment of the invention, processors 1270 and 1280 are respectively processors 1110 and 1115, while coprocessor 1238 is coprocessor 1145. In another embodiment, processors 1270 and 1280 are respectively processor 1110 coprocessor 1145.

Processors 1270 and 1280 are shown including integrated memory controller (IMC) units 1272 and 1282, respectively. Processor 1270 also includes as part of its bus controller units point-to-point (P-P) interfaces 1276 and 1278; similarly, second processor 1280 includes P-P interfaces 1286 and 1288. Processors 1270, 1280 may exchange information via a point-to-point (P-P) interface 1250 using P-P interface circuits 1278, 1288. As shown in FIG. 12, IMCs 1272 and 1282 couple the processors to respective memories, namely a memory 1232 and a memory 1234, which may be portions of main memory locally attached to the respective processors.

Processors 1270, 1280 may each exchange information with a chipset 1290 via individual P-P interfaces 1252, 1254 using point to point interface circuits 1276, 1294, 1286, 1298. Chipset 1290 may optionally exchange information with the coprocessor 1238 via a high-performance interface 1239. In one embodiment, the coprocessor 1238 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1290 may be coupled to a first bus 1216 via an interface 1296. In one embodiment, first bus 1216 may be a Peripheral Component Interconnect (PCI) bus, or a bus such as a PCI Express bus or another third generation I/O interconnect bus, although the scope of the present invention is not so limited.

As shown in FIG. 12, various I/O devices 1214 may be coupled to first bus 1216, along with a bus bridge 1218 which couples first bus 1216 to a second bus 1220. In one embodiment, one or more additional processor(s) 1215, such as coprocessors, high-throughput MIC processors, GPGPU's, accelerators (such as, e.g., graphics accelerators or digital signal processing (DSP) units), field programmable gate arrays, or any other processor, are coupled to first bus 1216. In one embodiment, second bus 1220 may be a low pin count (LPC) bus. Various devices may be coupled to a second bus 1220 including, for example, a keyboard and/or mouse 1222, communication devices 1227 and a storage unit 1228 such as a disk drive or other mass storage device which may include instructions/code and data 1230, in one embodiment. Further, an audio I/O 1224 may be coupled to the second bus 1220. Note that other architectures are possible. For example, instead of the point-to-point architecture of FIG. 12, a system may implement a multi-drop bus or other such architecture.

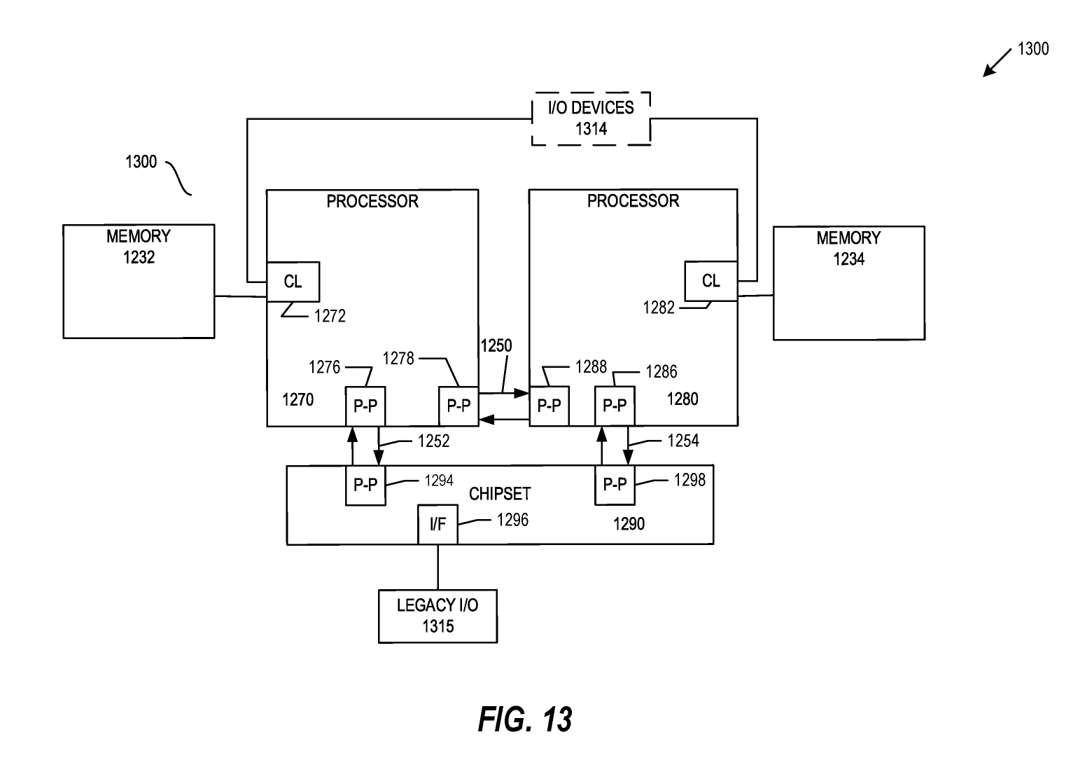

Referring now to FIG. 13, shown is a block diagram of a second more specific exemplary system 1300 in accordance with an embodiment of the present invention. Like elements in FIGS. 12 and 13 bear like reference numerals, and certain aspects of FIG. 12 have been omitted from FIG. 13 in order to avoid obscuring other aspects of FIG. 13.

FIG. 13 illustrates that the processors 1270, 1280 may include integrated memory and I/O control logic (“CL”) 1272 and 1282, respectively. Thus, the CL 1272, 1282 include integrated memory controller units and include I/O control logic. FIG. 13 illustrates that not only are the memories 1232, 1234 coupled to the CL 1272, 1282, but also that I/O devices 1314 are also coupled to the control logic 1272, 1282. Legacy I/O devices 1315 are coupled to the chipset 1290.

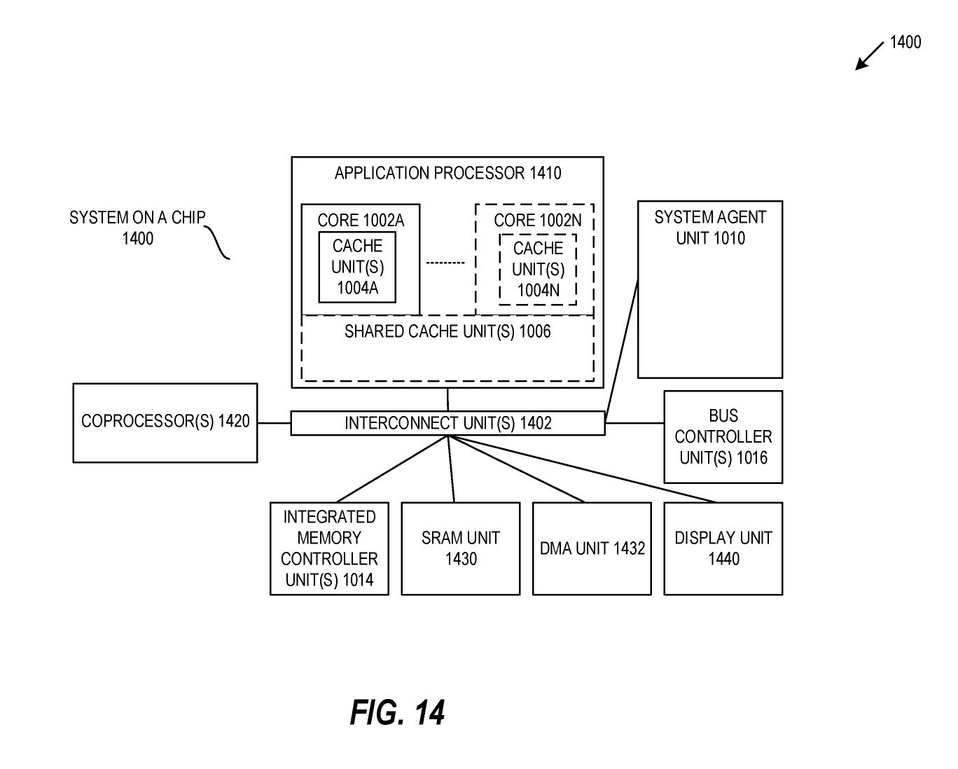

Referring now to FIG. 14, shown is a block diagram of a SoC 1400 in accordance with an embodiment of the present invention. Similar elements in FIG. 10 bear like reference numerals. Also, dashed lined boxes are optional features on more advanced SoCs. In FIG. 14, an interconnect unit(s) 1402 is coupled to: an application processor 1410 which includes a set of one or more cores 202A-N and shared cache unit(s) 1006; a system agent unit 1010; a bus controller unit(s) 1016; an integrated memory controller unit(s) 1014; a set or one or more coprocessors 1420 which may include integrated graphics logic, an image processor, an audio processor, and a video processor; an static random access memory (SRAM) unit 1430; a direct memory access (DMA) unit 1432; and a display unit 1440 for coupling to one or more external displays. In one embodiment, the coprocessor(s) 1420 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 1230 illustrated in FIG. 12, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

### Emulation (Including Binary Translation, Code Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

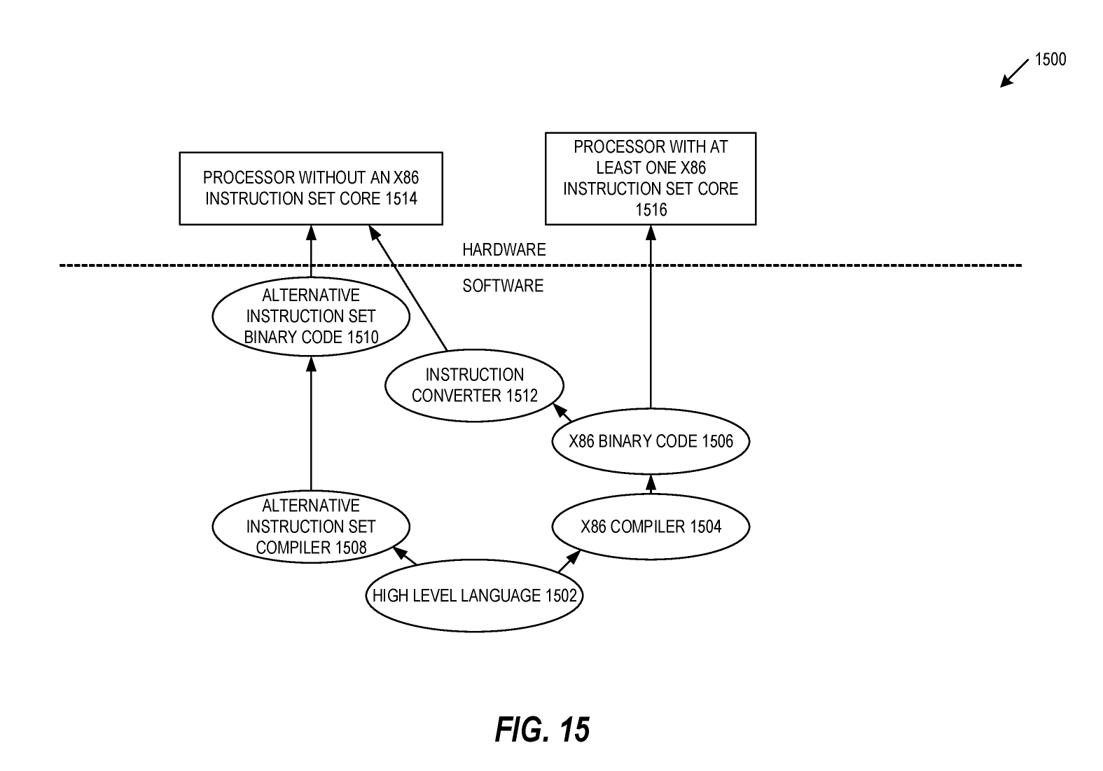

FIG. 15 is a block diagram contrasting the use of a software instruction converter to convert binary instructions in a source instruction set to binary instructions in a target instruction set according to an embodiment. In the illustrated embodiment, the instruction converter is a software instruction converter, although alternatively the instruction converter may be implemented in software, firmware, hardware, or various combinations thereof. FIG. 15 shows a program in a high level language 1502 may be compiled using an x86 compiler 1504 to generate x86 binary code 1506 that may be natively executed by a processor with at least one x86 instruction set core 1516. The processor with at least one x86 instruction set core 1516 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1504 represents a compiler that is operable to generate x86 binary code 1506 (e.g., object code) that can, with or without additional linkage processing, be executed on the processor with at least one x86 instruction set core 1516. Similarly, FIG. 15 shows the program in the high level language 1502 may be compiled using an alternative instruction set compiler 1508 to generate alternative instruction set binary code 1510 that may be natively executed by a processor without at least one x86 instruction set core 1514 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1512 is used to convert the x86 binary code 1506 into code that may be natively executed by the processor without an x86 instruction set core 1514. This converted code is not likely to be the same as the alternative instruction set binary code 1510 because an instruction converter capable of this is difficult to make; however, the converted code will accomplish the general operation and be made up of instructions from the alternative instruction set. Thus, the instruction converter 1512 represents software, firmware, hardware, or a combination thereof that, through emulation, simulation or any other process, allows a processor or other electronic device that does not have an x86 instruction set processor or core to execute the x86 binary code 1506.

To better illustrate the method and apparatuses disclosed herein, a non-limiting list of embodiments is provided here.

Example 1 is a hardware-implemented stream cache circuitry comprising: a stream cache next line predictor to: receive a memory block address A; determine a stable line of memory blocks includes the memory block address A followed by a memory block address B; and send a stream cache predictor instruction based on the memory block address B; a stream cache pointer array to receive the stream cache predictor instruction from the stream cache next line predictor and send a block B retrieval instruction; and a micro-ops cache data array to: store a plurality of previously fetched memory blocks; receive the block B retrieval instruction; and retrieve a memory block B from the stored plurality of previously fetched memory blocks.

In Example 2, the subject matter of Example 1 optionally includes the stream cache next line predictor further to: receive a plurality of memory block addresses; and determine the stable line of memory blocks, the stable line including a sequential subset of memory blocks within the plurality of memory block addresses.

In Example 3, the subject matter of Example 2 optionally includes wherein the stream cache next line includes a confidence counter to receive the plurality of memory block addresses and determine the stable line based on the plurality of memory block addresses.

In Example 4, the subject matter of any one or more of Examples 1-3 optionally include a cache tag array to receive the memory block address A and send a block A retrieval instruction to the micro-ops cache data array, the micro-ops cache data array to receive the cache tag array instruction and retrieve a memory block A from the stored plurality of previously fetched memory blocks.

In Example 5, the subject matter of Example 4 optionally includes the stream cache next line predictor further to: determine the stable line of memory blocks includes the memory block address C following the memory block address B; and send a next instruction protocol instruction based on the memory block address C, the next instruction protocol instruction causing the cache tag array and micro-ops cache data array to retrieve a memory block C from the stored plurality of previously fetched memory blocks.

In Example 6, the subject matter of Example 5 optionally includes a next instruction protocol multiplexer to: receive the next instruction protocol instruction from the stream cache next line predictor; and send the memory block address C to the cache tag array.

In Example 7, the subject matter of Example 6 optionally includes an address adder to: receive a previous memory address from the next instruction protocol multiplexer; generate an incremented memory address based on the previous memory address; and send the incremented memory address to the next instruction protocol multiplexer.

In Example 8, the subject matter of any one or more of Examples 4-7 optionally include a branch predictor history register to store a branch predictor history.

In Example 9, the subject matter of Example 8 optionally includes the stream cache next line predictor further to send a history update instruction to the branch predictor history register to reflect retrieval of the memory block A followed by the memory block B.

Example 10 is a hardware-implemented stream cache method comprising: receiving a memory block address A at a stream cache next line predictor; determining, at the stream cache next line predictor, that a stable line of memory blocks includes the memory block address A followed by a memory block address B; sending a stream cache predictor instruction based on the memory block address B from the stream cache next line predictor to a stream cache pointer array; sending a block B retrieval instruction from the stream cache pointer array to a micro-ops cache data array; storing a plurality of previously fetched memory blocks at a micro-ops cache data array; receiving the block B retrieval instruction at the micro-ops cache data array; and retrieving a memory block B from the plurality of previously fetched memory blocks stored within the micro-ops cache data array.

In Example 11, the subject matter of Example 10 optionally includes receiving a plurality of memory block addresses at the stream cache next line predictor; and determining the stable line of memory blocks at the stream cache next line predictor, the stable line including a sequential subset of memory blocks within the plurality of memory block addresses.

In Example 12, the subject matter of Example 11 optionally includes wherein the stream cache next line includes a confidence counter to receive the plurality of memory block addresses and determine the stable line based on the plurality of memory block addresses.

In Example 13, the subject matter of any one or more of Examples 10-12 optionally include receiving the memory block address A at a cache tag array; sending a block A retrieval instruction from the cache tag array to the micro-ops cache data array; receiving the cache tag array instruction at the micro-ops cache data array; and retrieving a memory block A from the plurality of previously fetched memory blocks stored in the micro-ops cache data array.

In Example 14, the subject matter of Example 13 optionally includes determining, at the stream cache next line predictor, that the stable line of memory blocks includes the memory block address C following the memory block address B; sending a next instruction protocol instruction based on the memory block address C; and retrieving a memory block C from the plurality of previously fetched memory blocks stored in the micro-ops cache data array based on the next instruction protocol instruction.

In Example 15, the subject matter of Example 14 optionally includes receiving the next instruction protocol instruction at a next instruction protocol multiplexer from the stream cache next line predictor; and sending the memory block address C from the next instruction protocol multiplexer to the cache tag array.

In Example 16, the subject matter of Example 15 optionally includes receiving a previous memory address at an address adder from the next instruction protocol multiplexer; generating, at the address adder, an incremented memory address based on the previous memory address; and sending the incremented memory address from the address adder to the next instruction protocol multiplexer.

In Example 17, the subject matter of any one or more of Examples 13-16 optionally include storing a branch predictor history at a branch predictor history register.

In Example 18, the subject matter of Example 17 optionally includes sending a history update instruction from the stream cache next line predictor to the branch predictor history register to reflect retrieval of the memory block A followed by the memory block B.

Example 19 is at least one machine-readable medium including instructions, which when executed by a computing system, cause the computing system to perform any of the methods of Examples 10-18.

Example 20 is an apparatus comprising means for performing any of the methods of Examples 10-18.

Example 21 is at least one non-transitory machine-readable storage medium, comprising a plurality of instructions that, responsive to being executed with processor circuitry of a computer-controlled device, cause the computer-controlled device to: receive a memory block address A at a stream cache next line predictor; determine, at the stream cache next line predictor, that a stable line of memory blocks includes the memory block address A followed by a memory block address B; send a stream cache predictor instruction based on the memory block address B from the stream cache next line predictor to a stream cache pointer array; send a block B retrieval instruction from the stream cache pointer array to a micro-ops cache data array; store a plurality of previously fetched memory blocks at a micro-ops cache data array; receive the block B retrieval instruction at the micro-ops cache data array; and retrieve a memory block B from the plurality of previously fetched memory blocks stored within the micro-ops cache data array.

In Example 22, the subject matter of Example 21 optionally includes the instructions further causing the computer-controlled device to: receive a plurality of memory block addresses at the stream cache next line predictor; and determine the stable line of memory blocks at the stream cache next line predictor, the stable line including a sequential subset of memory blocks within the plurality of memory block addresses.

In Example 23, the subject matter of Example 22 optionally includes wherein the stream cache next line includes a confidence counter to determine the stable line based on the plurality of memory block addresses.

In Example 24, the subject matter of any one or more of Examples 21-23 optionally include the instructions further causing the computer-controlled device to: receive the memory block address A at a cache tag array; send a block A retrieval instruction from the cache tag array to the micro-ops cache data array; receive the cache tag array instruction at the micro-ops cache data array; and retrieve a memory block A from the plurality of previously fetched memory blocks stored in the micro-ops cache data array.

In Example 25, the subject matter of Example 24 optionally includes the instructions further causing the computer-controlled device to: determine, at the stream cache next line predictor, that the stable line of memory blocks includes the memory block address C following the memory block address B; send a next instruction protocol instruction based on the memory block address C; and retrieve a memory block C from the plurality of previously fetched memory blocks stored in the micro-ops cache data array based on the next instruction protocol instruction.

In Example 26, the subject matter of Example 25 optionally includes the instructions further causing the computer-controlled device to: receive the next instruction protocol instruction at a next instruction protocol multiplexer from the stream cache next line predictor; and send the memory block address C from the next instruction protocol multiplexer to the cache tag array.

In Example 27, the subject matter of Example 26 optionally includes the instructions further causing the computer-controlled device to: receive a previous memory address at an address adder from the next instruction protocol multiplexer; generating, at the address adder, an incremented memory address based on the previous memory address; and send the incremented memory address from the address adder to the next instruction protocol multiplexer.

In Example 28, the subject matter of any one or more of Examples 24-27 optionally include the instructions further causing the computer-controlled device to store a branch predictor history at a branch predictor history register.

In Example 29, the subject matter of Example 28 optionally includes the instructions further causing the computer-controlled device to send a history update instruction from the stream cache next line predictor to the branch predictor history register to reflect retrieval of the memory block A followed by the memory block B.

Example 30 is a hardware-implemented stream cache apparatus comprising: means for receiving a memory block address A at a stream cache next line predictor; means for determining, at the stream cache next line predictor, that a stable line of memory blocks includes the memory block address A followed by a memory block address B; means for sending a stream cache predictor instruction based on the memory block address B from the stream cache next line predictor to a stream cache pointer array; means for sending a block B retrieval instruction from the stream cache pointer array to a micro-ops cache data array; means for storing a plurality of previously fetched memory blocks at a micro-ops cache data array; means for receiving the block B retrieval instruction at the micro-ops cache data array; and means for retrieving a memory block B from the plurality of previously fetched memory blocks stored within the micro-ops cache data array.

In Example 31, the subject matter of Example 30 optionally includes means for receiving a plurality of memory block addresses at the stream cache next line predictor; and means for determining the stable line of memory blocks at the stream cache next line predictor, the stable line including a sequential subset of memory blocks within the plurality of memory block addresses.

In Example 32, the subject matter of Example 31 optionally includes wherein the means for determining the stable line based on the plurality of memory block addresses includes a confidence counter within the stream cache next line.

In Example 33, the subject matter of any one or more of Examples 30-32 optionally include means for receiving the memory block address A at a cache tag array; means for sending a block A retrieval instruction from the cache tag array to the micro-ops cache data array; means for receiving the cache tag array instruction at the micro-ops cache data array; and means for retrieving a memory block A from the plurality of previously fetched memory blocks stored in the micro-ops cache data array.

In Example 34, the subject matter of Example 33 optionally includes means for determining, at the stream cache next line predictor, that the stable line of memory blocks includes the memory block address C following the memory block address B; means for sending a next instruction protocol instruction based on the memory block address C; and means for retrieving a memory block C from the plurality of previously fetched memory blocks stored in the micro-ops cache data array based on the next instruction protocol instruction.

In Example 35, the subject matter of Example 34 optionally includes means for receiving the next instruction protocol instruction at a next instruction protocol multiplexer from the stream cache next line predictor; and means for sending the memory block address C from the next instruction protocol multiplexer to the cache tag array.

In Example 36, the subject matter of Example 35 optionally includes means for receiving a previous memory address at an address adder from the next instruction protocol multiplexer; means for generating, at the address adder, an incremented memory address based on the previous memory address; and means for sending the incremented memory address from the address adder to the next instruction protocol multiplexer.

In Example 37, the subject matter of any one or more of Examples 33-36 optionally include means for storing a branch predictor history at a branch predictor history register.

In Example 38, the subject matter of Example 37 optionally includes means for sending a history update instruction from the stream cache next line predictor to the branch predictor history register to reflect retrieval of the memory block A followed by the memory block B.

Example 39 is at least one machine-readable medium including instructions, which when executed by a machine, cause the machine to perform operations of any of the operations of Examples 1-38.

Example 40 is an apparatus comprising means for performing any of the operations of Examples 1-38.

Example 41 is a system to perform the operations of any of the Examples 1-38.

Example 42 is a method to perform the operations of any of the Examples 1-38.

The above detailed description includes references to the accompanying drawings, which form a part of the detailed description. The drawings show, by way of illustration, specific embodiments in which the subject matter can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. In the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope should be determined with reference to the appended claims, along with the full scope of equivalents to which such claims are entitled.

1. A hardware-implemented stream cache circuitry comprising:
a processor front end circuit including:
a stream cache next line predictor circuit to:
obtain a first memory block address;
determine a stable line of memory blocks includes the first memory block address followed by a second memory block address; and
provide a stream cache predictor memory address based on the second memory block address; and
a stream cache pointer array to obtain the stream cache predictor memory address from the stream cache next line predictor circuit and provide a second block retrieval memory address; and
a processor micro-ops cache within a processor data array circuit, the micro-cops cache to:
store a plurality of previously fetched memory blocks;
obtain the second block retrieval memory address; and
retrieve a second memory block from the stored plurality of previously fetched memory blocks.

2. The circuitry of claim 1, the stream cache next line predictor circuit further to:
obtain a plurality of memory block addresses; and
determine the stable line of memory blocks, the stable line including a sequential subset of memory blocks within the plurality of memory block addresses.

3. The circuitry of claim 2, wherein the stream cache next line includes a confidence counter to obtain the plurality of memory block addresses and determine the stable line based on the plurality of memory block addresses.

4. The circuitry of claim 1, further including a cache tag array to obtain the first memory block address and provide a first block retrieval memory address to the processor micro-ops cache, the processor micro-ops cache to obtain the first block retrieval memory address and retrieve a first memory block from the stored plurality of previously fetched memory blocks.

5. The circuitry of claim 4, the stream cache next line predictor circuit further to:
determine the stable line of memory blocks includes the third memory block address following the second memory block address; and
provide a next instruction protocol memory address based on the third memory block address, the next instruction protocol memory address causing the cache tag array and processor micro-ops cache to retrieve a third memory block from the stored plurality of previously fetched memory blocks.

6. The circuitry of claim 5, further including a next instruction protocol multiplexer to:
obtain the next instruction protocol memory address from the stream cache next line predictor circuit; and
provide the third memory block address to the cache tag array.

7. The circuitry of claim 4, further including a branch predictor history register to store a branch predictor history.

8. The circuitry of claim 7, the stream cache next line predictor circuit further to provide a history update instruction to the branch predictor history register to reflect retrieval of the first memory block followed by the second memory block.

9. A hardware-implemented stream cache method comprising:
obtaining a first memory block address at a stream cache next line predictor circuit within a processor front end circuit;
determining, at the stream cache next line predictor circuit, that a stable line of memory blocks includes the first memory block address followed by a second memory block address;
providing a stream cache predictor memory address based on the second memory block address from the stream cache next line predictor circuit to a stream cache pointer array circuit within the processor front end circuit;
providing a second block retrieval memory address from the stream cache pointer array to a processor micro-ops cache within a processor data array circuit;
storing a plurality of previously fetched memory blocks at the processor micro-ops cache;
obtaining the second block retrieval memory address at the processor micro-ops cache; and
retrieving a second memory block from the plurality of previously fetched memory blocks stored within the processor micro-ops cache.

10. The method of claim 9, further including:
obtaining a plurality of memory block addresses at the stream cache next line predictor circuit; and
determining the stable line of memory blocks at the stream cache next line predictor circuit, the stable line including a sequential subset of memory blocks within the plurality of memory block addresses.

11. The method of claim 10, wherein the stream cache next line includes a confidence counter to obtain the plurality of memory block addresses and determine the stable line based on the plurality of memory block addresses.

12. The method of claim 9, further including:
obtaining the first memory block address at a cache tag array;
providing a first block retrieval memory address from the cache tag array to the processor micro-ops cache;
obtaining the first block retrieval memory address at the processor micro-ops cache; and
retrieving a first memory block from the plurality of previously fetched memory blocks stored in the processor micro-ops cache.

13. The method of claim 12, further including:
determining, at the stream cache next line predictor circuit, that the stable line of memory blocks includes the third memory block address following the second memory block address;
providing a next instruction protocol memory address based on the third memory block address; and
retrieving a third memory block from the plurality of previously fetched memory blocks stored in the processor micro-ops cache based on the next instruction protocol memory address.

14. The method of claim 13, further including:
obtaining the next instruction protocol memory address at a next instruction protocol multiplexer from the stream cache next line predictor circuit; and
providing the third memory block address from the next instruction protocol multiplexer to the cache tag array.

15. The method of claim 12, further including storing a branch predictor history at a branch predictor history register.

16. The method of claim 15, further including providing a history update instruction from the stream cache next line predictor circuit to the branch predictor history register to reflect retrieval of the first memory block followed by the second memory block.

17. At least one non-transitory machine-readable storage medium, comprising a plurality of instructions that, responsive to being executed with processor circuitry of a computer-controlled device, cause the computer-controlled device to:
obtain a first memory block address at a stream cache next line predictor circuit within a processor front end circuit;
determine, at the stream cache next line predictor circuit, that a stable line of memory blocks includes the first memory block address followed by a second memory block address;
provide a stream cache predictor memory address based on the second memory block address from the stream cache next line predictor circuit to a stream cache pointer array circuit within the processor front end circuit;
provide a second block retrieval memory address from the stream cache pointer array to a processor micro-ops cache within a processor data array circuit;
store a plurality of previously fetched memory blocks at the processor micro-ops cache;
obtain the second block retrieval memory address at the processor micro-ops cache; and
retrieve a second memory block from the plurality of previously fetched memory blocks stored within the processor micro-ops cache.

18. The machine-readable storage medium of claim 17, the instructions further causing the computer-controlled device to:
obtain a plurality of memory block addresses at the stream cache next line predictor circuit; and
determine the stable line of memory blocks at the stream cache next line predictor circuit, the stable line including a sequential subset of memory blocks within the plurality of memory block addresses.

19. The machine-readable storage medium of claim 18, wherein the stream cache next line includes a confidence counter to determine the stable line based on the plurality of memory block addresses.

20. The machine-readable storage medium of claim 17, the instructions further causing the computer-controlled device to:
obtain the first memory block address at a cache tag array;
provide a first block retrieval memory address from the cache tag array to the processor micro-ops cache;
obtain the first block retrieval memory address at the processor micro-ops cache; and
retrieve a first memory block from the plurality of previously fetched memory blocks stored in the processor micro-ops cache.

21. The machine-readable storage medium of claim 20, the instructions further causing the computer-controlled device to:
determine, at the stream cache next line predictor circuit, that the stable line of memory blocks includes the third memory block address following the second memory block address;
provide a next instruction protocol memory address based on the third memory block address; and
retrieve a third memory block from the plurality of previously fetched memory blocks stored in the processor micro-ops cache based on the next instruction protocol memory address.

22. The machine-readable storage medium of claim 21, the instructions further causing the computer-controlled device to:
obtain the next instruction protocol memory address at a next instruction protocol multiplexer from the stream cache next line predictor circuit; and
provide the third memory block address from the next instruction protocol multiplexer to the cache tag array.

23. The machine-readable storage medium of claim 22, the instructions further causing the computer-controlled device to:
obtain a previous memory address at an address adder from the next instruction protocol multiplexer;
generating, at the address adder, an incremented memory address based on the previous memory address; and
provide the incremented memory address from the address adder to the next instruction protocol multiplexer.

24. The machine-readable storage medium of claim 20, the instructions further causing the computer-controlled device to store a branch predictor history at a branch predictor history register.

25. The machine-readable storage medium of claim 24, the instructions further causing the computer-controlled device to provide a history update instruction from the stream cache next line predictor circuit to the branch predictor history register to reflect retrieval of the first memory block followed by the second memory block.
